(19) United States
(12) Patent Application Publication
(10) Pub. No.: US 2025/0048407 A1
(43) Pub. Date: Feb. 6, 2025

(54) Sidelink Positioning Initialization in 5G networks

(71) Applicant: Huawei Technologies Co., Ltd., Shenzhen (CN)

(72) Inventors: Guosen Yue, Addison, TX (US); Brian Classon, Addison, TX (US); George Calcev, Addison, TX (US); Vipul Desai, Addison, TX (US)

(21) Appl. No.: 18/927,537

(22) Filed: Oct. 25, 2024

Related U.S. Application Data
(63) Continuation of application No. PCT/US2023/020460, filed on Apr. 28, 2023.
(60) Provisional application No. 63/336,046, filed on Apr. 28, 2022.

(51) Int. Cl. H04W 72/40; G01S 13/76; H04L 5/00; H04W 72/02

(52) U.S. Cl. CPC H04W 72/40; G01S 13/765; H04L 5/0048; H04W 72/02

(57) ABSTRACT

A mechanism is disclosed for performing sidelink positioning between a target user equipment (UE) and an anchor UE, with or without interaction with a fifth generation radio access network (5G) base station (gNB). The mechanism includes transmitting a positioning request from a target UE to one or more anchor UEs via a sidelink communication. Positioning signal received from the one or more anchor UEs via the sidelink communication. Positioning measurement is performed based on the positioning signal.

### CROSS-REFERENCE TO RELATED APPLICATIONS

This patent application is a continuation of International Application No. PCT/US2023/020460, filed Apr. 28, 2023 by Guosen Yue, et. al., and titled “Sidelink Positioning Initialization in 5G networks” which claims the benefit of U.S. Provisional Patent Application No. 63/336,046, filed Apr. 28, 2022 by Guosen Yue, et. al. and titled “Method and Apparatus of Sidelink Positioning,” which is hereby incorporated by reference.

### TECHNICAL FIELD

The present disclosure is generally related to fifth generation radio access network (5G) network technology, and is specifically related to initialization of sidelink communication between anchor user equipment (UE) and a target UE to support sidelink positioning with or without reliance on the 5G network for resource communication allocation.

### BACKGROUND

Several features associated with fifth generation (5G) new radio access technology are under development and standardization by the third-generation partnership project (3GPP). As an example, one work item includes a request for a 5G new radio (NR) vehicle-to-everything (V2X) wireless communication mechanism with the goal of providing 5G-compatible high-speed reliable connectivity for vehicular communications.

### SUMMARY

In an embodiment, the disclosure includes a method implemented by a target User Equipment (UE). The method comprises transmitting a positioning request to one or more anchor UEs via a sidelink communication. The method further comprises receiving a positioning signal from the one or more anchor UEs via the sidelink communication. The method further comprises performing a positioning measurement based on the positioning signal. UEs, such as vehicles, phone, computers, tablets, industrial devices, or other wireless network based computing devices, may desire to determine a current location/position. Further, such devices may travel out of network range, such that the network is not capable of using positioning systems to provide the location/position to the UE. The present aspect includes a mechanism for initiating sidelink positioning between an anchor UE and a target UE. Sidelink positioning is a mechanism that allows either an anchor UE or a target UE to determine the location of the target UE relative to the anchor UE via a sidelink communication between the target UE and the anchor UE, for example without direct interaction by a corresponding 5G network. Anchor UE(s) can indicate each UE's willingness and capabilities to act as an anchor UE via signaling. The target UE can then select one or more anchor UEs. The target UE and the anchor UE can reserve time and frequency communication resources for signaling via opportunistic mechanisms or via assignment by a 5G network. A positioning request is then sent. The request can be sent by the target UE to one or more anchor UEs. In another example, the request can be sent by an anchor UE to the target UE. In another example, an anchor UE can act as a serving anchor UE and can send a request to the target UE and to coordinating anchor UEs or to the target UE for further communication to the coordinating anchor UEs. Upon receiving a request, an anchor UE responds with position information. In an example, the request is triggered by conditions. In other examples, the position information is sent based on conditions without a request. Once the position information has been sent, the target UE can either measure the location of the target UE or send the position information back to an anchor UE, such as a serving anchor UE, to allow the anchor UE to measure the location of the target UE. Position information from coordinating UEs can also be sent to a serving anchor UE, either directly or via target UE. By using one or more of these mechanisms, an exchange of position information is triggered via a sidelink communication (e.g., directly between the UEs without interaction by the 5G network.) The UEs can then determine the position of the target UE by measurements made on the position information without the need to rely on location systems in the 5G network. As such, the present mechanisms cause UEs to perform beneficial functions, such as allowing UEs (e.g. vehicles) to determine their position even when outside the range of network coverage.

Optionally, in any of the preceding aspects, another implementation of the aspect provides, wherein the target UE communicates with the one or more anchor UEs in accordance with sensing based resource selection of sidelink resources.

Optionally, in any of the preceding aspects, another implementation of the aspect provides, wherein the target UE communicates with the one or more anchor UEs via resource reservations provided by a fifth generation (5G) base station (gNB).

Optionally, in any of the preceding aspects, another implementation of the aspect provides, wherein the positioning signal comprises a sidelink positioning reference signal (SL-Pos-RS).

Optionally, in any of the preceding aspects, another implementation of the aspect provides, further comprising selecting the one or more anchor UEs prior to transmitting the positioning request to the anchor UEs.

Optionally, in any of the preceding aspects, another implementation of the aspect provides, further comprising estimating a location of the target UE based on the positioning measurement and locations of the one or more anchor nodes.

Optionally, in any of the preceding aspects, another implementation of the aspect provides, further comprising receiving an initial positioning request from a serving anchor UE via the sidelink communication prior to transmitting the positioning request to the anchor UEs.

Optionally, in any of the preceding aspects, another implementation of the aspect provides, further comprising sending the position measurements to the serving anchor UE via the sidelink communication for estimation of a location of the target UE.

Optionally, in any of the preceding aspects, another implementation of the aspect provides, wherein transmitting the positioning request is triggered by a condition.

Optionally, in any of the preceding aspects, another implementation of the aspect provides, wherein the condition includes reference signal received power (RSRP) relative to a first threshold, a distance relative to a second threshold, a number of UE anchors relative to a third threshold, a channel condition relative to a fourth threshold, or combinations thereof.

Optionally, in any of the preceding aspects, another implementation of the aspect provides, wherein the one or more anchor UEs are selected based on UE anchor indication and UE anchor levels.

Optionally, in any of the preceding aspects, another implementation of the aspect provides, wherein the UE anchor indication indicates whether a corresponding UE is capable of acting as an anchor UE and whether the corresponding UE is allowed to act as an anchor UE.

Optionally, in any of the preceding aspects, another implementation of the aspect provides, wherein the UE anchor levels are set based on a synchronization source, a priority level, location accuracy, a maximum bandwidth, an in-coverage indicator, a sidelink synchronization signal identifier (SLSSID), or combinations thereof.

Optionally, in any of the preceding aspects, another implementation of the aspect provides, further comprising reselecting the one or more anchor UEs after obtaining anchor UE position, channel measurements, timing measurements, or combinations thereof.

In an embodiment, the disclosure includes a method implemented by an anchor User Equipment (UE). The method comprises transmitting a positioning request to a target UE via a sidelink communication. The method further comprises receiving a positioning signal from the target UE via the sidelink communication. The method further comprises performing a positioning measurement for the target UE based on the positioning signal. UEs, such as vehicles, phone, computers, tablets, industrial devices, or other wireless network based computing devices, may desire to determine a current location/position. Further, such devices may travel out of network range, such that the network is not capable of using positioning systems to provide the location/position to the UE. The present aspect includes a mechanism for initiating sidelink positioning between an anchor UE and a target UE. Sidelink positioning is a mechanism that allows either an anchor UE or a target UE to determine the location of the target UE relative to the anchor UE via a sidelink communication between the target UE and the anchor UE, for example without direct interaction by a corresponding 5G network. Anchor UE(s) can indicate each UE's willingness and capabilities to act as an anchor UE via signaling. The target UE can then select one or more anchor UEs. The target UE and the anchor UE can reserve time and frequency communication resources for signaling via opportunistic mechanisms or via assignment by a 5G network. A positioning request is then sent. The request can be sent by the target UE to one or more anchor UEs. In another example, the request can be sent by an anchor UE to the target UE. In another example, an anchor UE can act as a serving anchor UE and can send a request to the target UE and to coordinating anchor UEs or to the target UE for further communication to the coordinating anchor UEs. Upon receiving a request, an anchor UE responds with position information. In an example, the request is triggered by conditions. In other examples, the position information is sent based on conditions without a request. Once the position information has been sent, the target UE can either measure the location of the target UE or send the position information back to an anchor UE, such as a serving anchor UE, to allow the anchor UE to measure the location of the target UE. Position information from coordinating UEs can also be sent to a serving anchor UE, either directly or via the target UE. By using one or more of these mechanisms, an exchange of position information is triggered via a sidelink communication (e.g., directly between the UEs without interaction by the 5G network.) The UEs can then determine the position of the target UE by measurements made on the position information without the need to rely on location systems in the 5G network. As such, the present mechanisms cause UEs to perform beneficial functions, such as allowing UEs (e.g. vehicles) to determine their position even when outside the range of network coverage.

Optionally, in any of the preceding aspects, another implementation of the aspect provides, wherein the anchor UE communicates with the target UEs in accordance with sensing based resource selection of sidelink resources.

Optionally, in any of the preceding aspects, another implementation of the aspect provides, wherein the anchor UE communicates with the target UE via resource reservations provided by a fifth generation (5G) base station (gNB).

Optionally, in any of the preceding aspects, another implementation of the aspect provides, wherein the positioning signal comprises a sidelink positioning reference signal (SL-Pos-RS).

Optionally, in any of the preceding aspects, another implementation of the aspect provides, further comprising estimating a location of the target UE based on the positioning measurement.

Optionally, in any of the preceding aspects, another implementation of the aspect provides, wherein the positioning request signals the target UE to send one or more second positioning requests to one or more coordinating anchor UEs.

Optionally, in any of the preceding aspects, another implementation of the aspect provides, wherein the positioning signal from the target UE includes location information from the one or more coordinating anchor UEs.

Optionally, in any of the preceding aspects, another implementation of the aspect provides, further comprising receiving location information from the one or more coordinating anchor UEs.

Optionally, in any of the preceding aspects, another implementation of the aspect provides, further comprising transmitting one or more second positioning requests to one or more coordinating anchor UEs.

Optionally, in any of the preceding aspects, another implementation of the aspect provides, wherein the positioning request is triggered by a condition.

Optionally, in any of the preceding aspects, another implementation of the aspect provides, wherein the condition includes reference signal received power (RSRP) relative to a first threshold, a distance relative to a second threshold, a number of UE anchors relative to a third threshold, a channel condition relative to a fourth threshold, or combinations thereof.

Optionally, in any of the preceding aspects, another implementation of the aspect provides, further comprising transmitting a UE anchor indication that indicates whether the anchor UE is capable of acting as an anchor UE and whether the anchor UE is allowed to act as the anchor UE.

Optionally, in any of the preceding aspects, another implementation of the aspect provides, further comprising transmitting a UE anchor level set based on synchronization source, priority level, location accuracy, maximum bandwidth, in-coverage indicator, sidelink synchronization signal identifier (SLSSID), or combinations thereof.

Optionally, in any of the preceding aspects, another implementation of the aspect provides, wherein the one or more anchor UEs are selected in accordance to a line-of-sight (LOS)/non line-of-sight (NLOS) indicator.

Optionally, in any of the preceding aspects, another implementation of the aspect provides, wherein a sidelink positioning measurement report compromises a line-of-sight (LOS)/non line-of-sight (NLOS) indicator.

In an embodiment, the disclosure includes a UE comprising one or more processors, a transmitter coupled to the one or more processors, a receiver coupled to the one or more processors, wherein the one or more processors, transmitter, and receiver are configured to perform the method of any of the preceding aspects.

In an embodiment, the disclosure includes a non-transitory computer readable medium comprising a computer program product for use by a UE, the computer program product comprising computer executable instructions stored on the non-transitory computer readable medium such that when executed by one or more processors cause the UE to perform the method of any of the preceding aspects.

In an embodiment, the disclosure includes a UE comprising a transmitting means for transmitting a positioning request to one or more anchor UEs via a sidelink communication. The UE further comprises a receiving means for receiving a positioning signal from the one or more anchor UEs via the sidelink communication. The UE further comprises a measurement means for performing a positioning measurement based on the positioning signal.

Optionally, in any of the preceding aspects, another implementation of the aspect provides, wherein the UE is further configured to perform the method of any of the preceding aspects.

In an embodiment, the disclosure includes a UE comprising: a transmitting means for transmitting a positioning request to a target UE via a sidelink communication. The UE further comprises a receiving means for receiving a positioning signal from the target UE via the sidelink communication. The UE further comprises a measurement means for performing a positioning measurement for the target UE based on the positioning signal.

Optionally, in any of the preceding aspects, another implementation of the aspect provides, wherein the UE is further configured to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating an example of in network coverage operation and out of network coverage operation using 5G network compliant technology.

FIG. 2 is a schematic diagram of an example resource pool in a resource grid for sidelink communications.

FIG. 3 is a schematic diagram of an example resource grid with Physical sidelink control channel (PSCCH), Physical sidelink shared channel (PSSCH), and Physical sidelink feedback channel (PSFCH) resources.

FIG. 4 is a schematic diagram of an example structure of a sidelink synchronization signal block (S-SSB) block.

FIG. 5 is a schematic diagram of an example uplink (UL) sounding reference signal (SRS).

FIG. 6 is a schematic diagram of an example downlink (DL) positioning reference signal (PRS).

FIG. 7 is a schematic diagram of an example sensing and resource selection window.

FIG. 8 is a schematic diagram illustrating sidelink positioning.

FIG. 9 is a schematic diagram illustrating sidelink positioning triggered by a target UE.

FIG. 10 is a schematic diagram illustrating sidelink positioning triggered by an anchor UE.

FIG. 11 is a flowchart of an example method for positioning at a target UE triggered by a request.

FIG. 12 is a flowchart of an example method for a hybrid procedure for positioning at an anchor UE.

FIG. 13 is a flowchart of an example method for a UE to determine and indicate an anchor level to support UE anchor selection.

FIG. 14 is a flowchart of an example method for anchor UE selection.

FIG. 15 is a schematic diagram illustrating anchor UEs broadcasting sidelink positioning reference signals (SL-Pos-RS) and location information.

FIG. 16 is a schematic diagram of an example of line of sight (LOS) and non-line of sight (NLOS) sidelink positioning.

FIG. 17 is a schematic diagram of an example of positioning reference signal (PRS) resource set.

FIG. 18 is a schematic diagram of an example UL PRS resource configuration.

FIG. 19 is a schematic diagram of an example sidelink synchronization signal block (S-SSB).

FIG. 20 is a schematic diagram of an example UE for sidelink communication.

FIG. 21 is a schematic diagram of an example embodiment of a UE for sidelink positioning.

FIG. 22 is a flowchart of an example method of performing sidelink based positioning in a target UE.

FIG. 23 is a flowchart of an example method of performing sidelink based positioning in an anchor UE.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

3GPP provided the basics of NR sidelink communication for applications such as safety systems and autonomous driving. High data rates, low latencies, and high reliabilities were some of the areas investigated and standardized. 3GPP also provided a Sidelink Enhancement work item to further enhance the capabilities and performance of sidelink communication. One of the objectives of that work item was to introduce an inter-UE coordination mechanism where one UE shares preferred or non-preferred resources for another UE to use in its resource selection or sends a conflict indication to other UEs if there is a conflict on reserved resources.

A further work item requested NR positioning support, which provides positioning support in 5G NR including DL and UL reference signals for various positioning techniques (DL-TDOA, DL-AoD, UL-TDOA, UL-AoA, multi-cell RTT, and E-CID), as well as the UE and gNB measurements for NR positioning. A further work item requested NR Positioning enhancements with the goal of supporting high accuracy, low latency, network efficiency, and device efficiency requirements for commercial use cases. This work item was related to methods, measurements, signaling, and procedures for improving positioning accuracy over other example positioning methods. A study item on expanded and improved NR positioning and includes a study of sidelink positioning solutions. The present disclosure, describe techniques and signaling to enable sidelink positioning.

FIG. 1 is a schematic diagram illustrating an example 100 of in network coverage operation and out of network coverage operation using 5G network compliant technology. Sidelink communication can either be in-coverage, or out-of-coverage. With in-coverage (IC) operation, a central node 101 such as an 5G base station (gNB) or a fourth generation evolved node B base station (eNB) is present and can be used to manage a sidelink communication 103 between UEs 105. This is known as mode 1. In mode 2 operation, the system operation is fully distributed, and UEs 105 select resources on their own to support sidelink communication 103 between UEs 105. In this disclosure, some UEs could also be facilitated/assisted in selecting their resources. In mode 2, UEs can be either in-coverage or out-of-coverage (OOC).

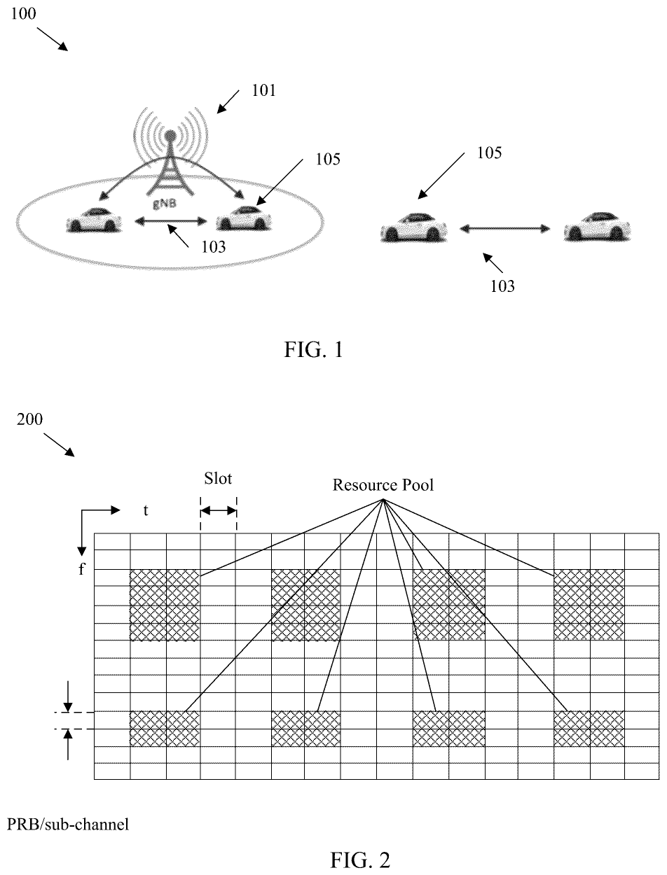

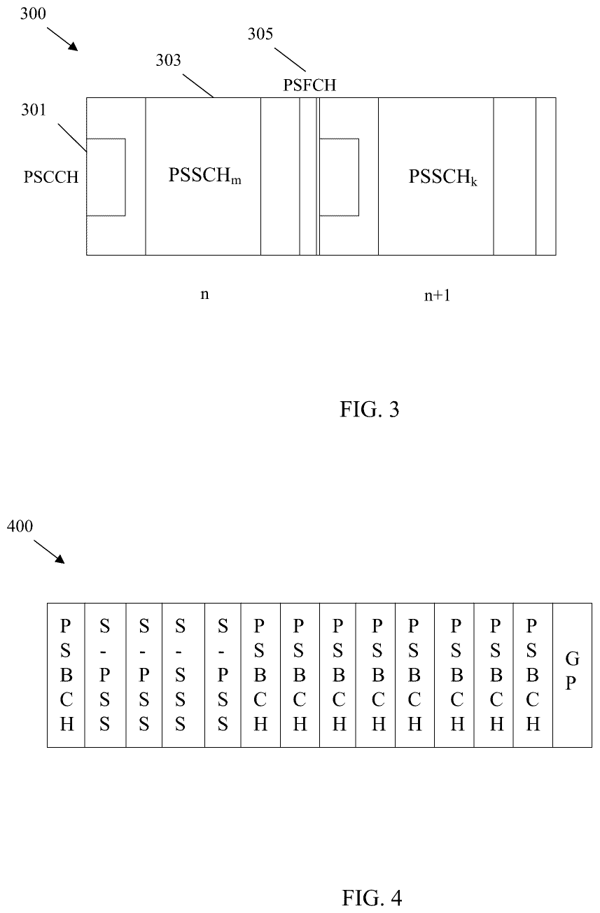

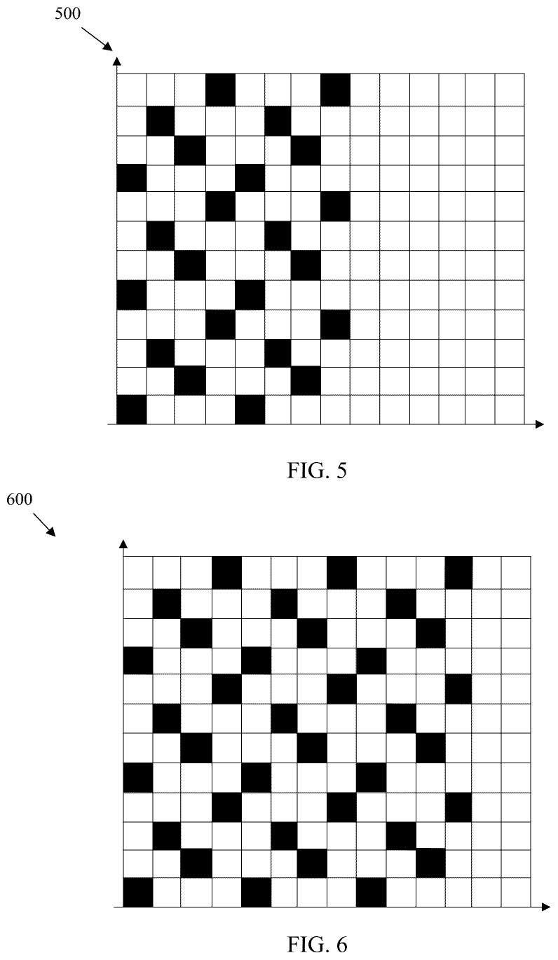

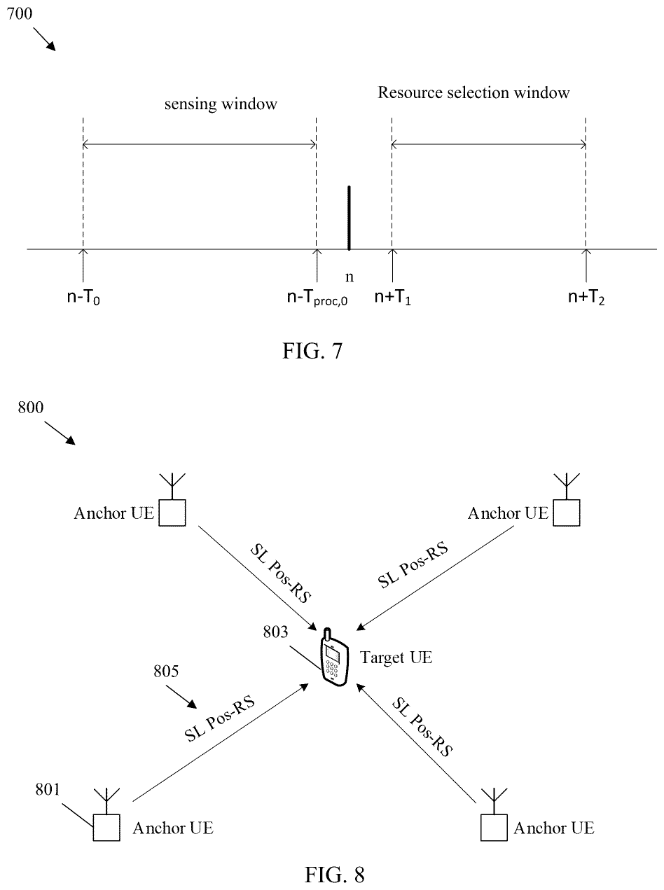

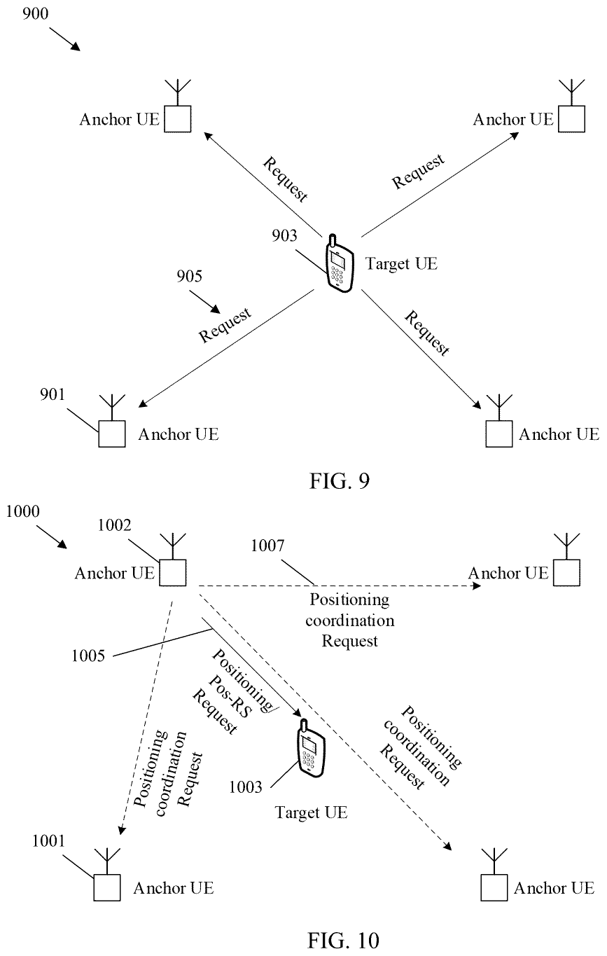

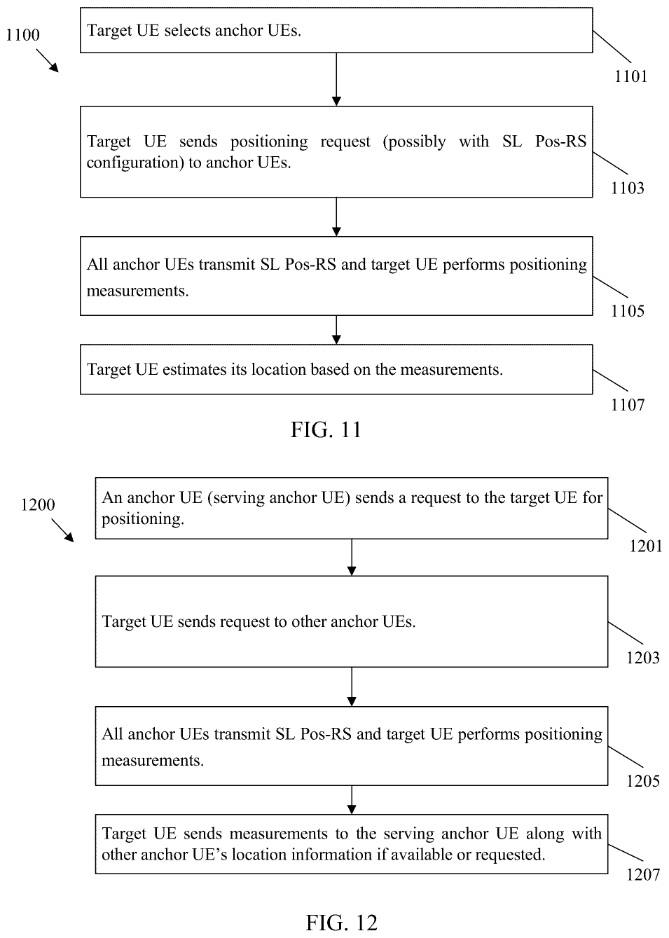

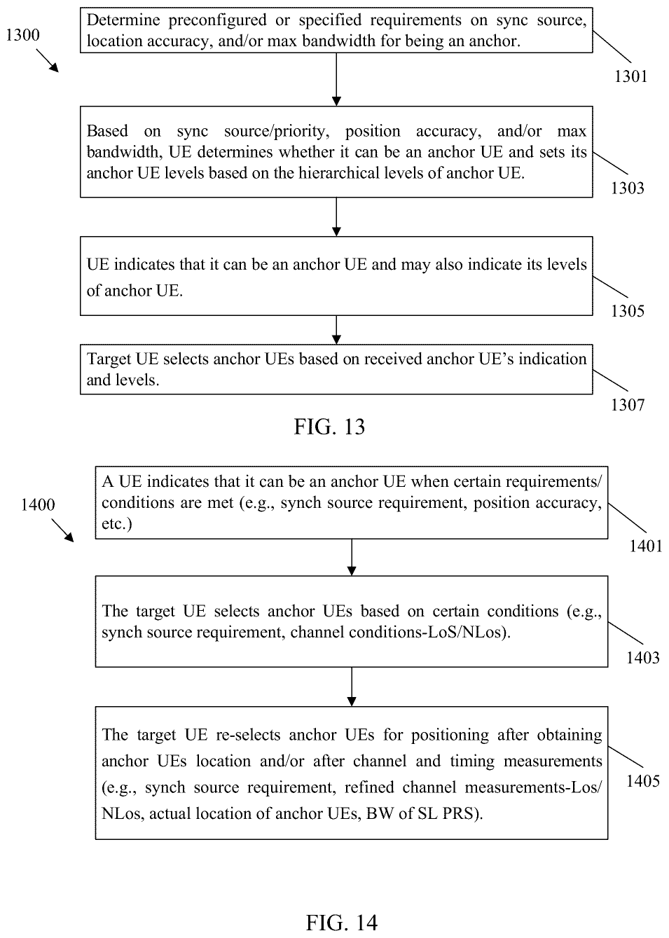

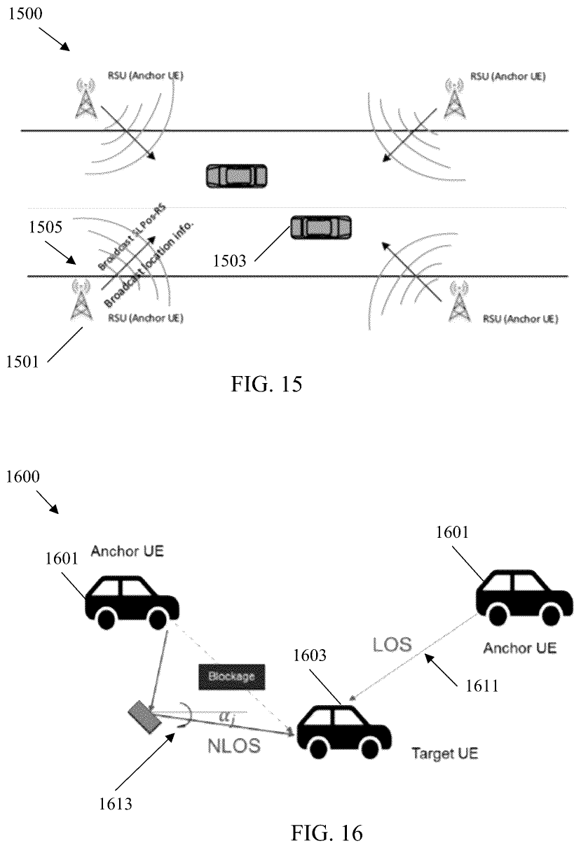

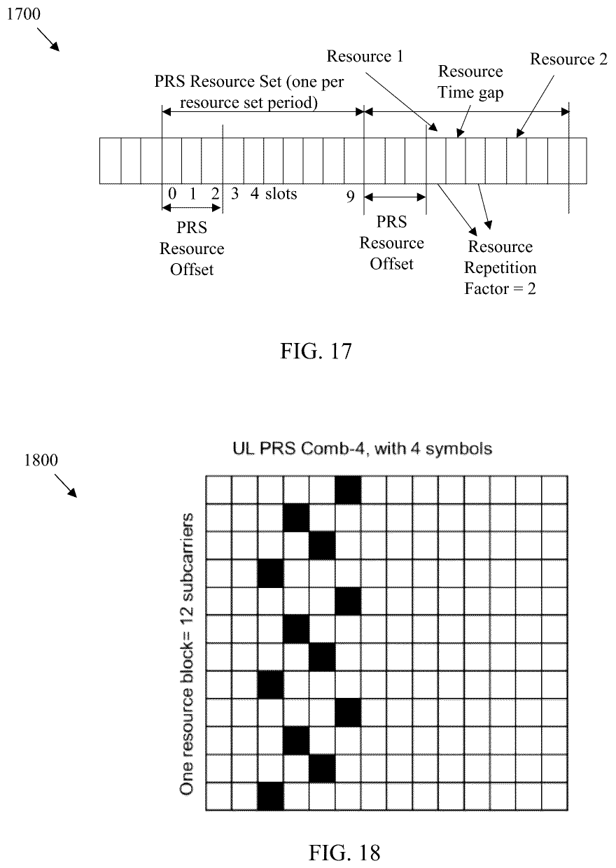

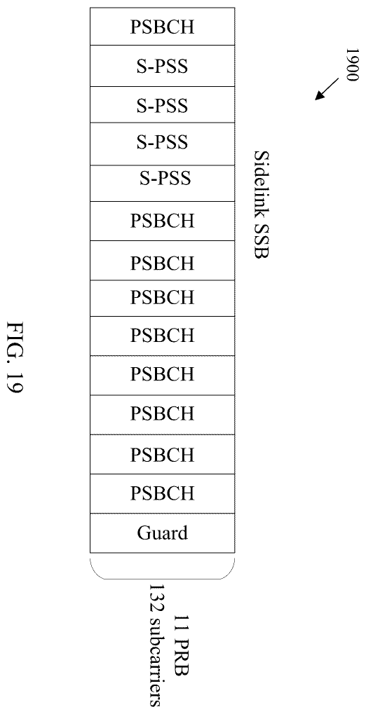

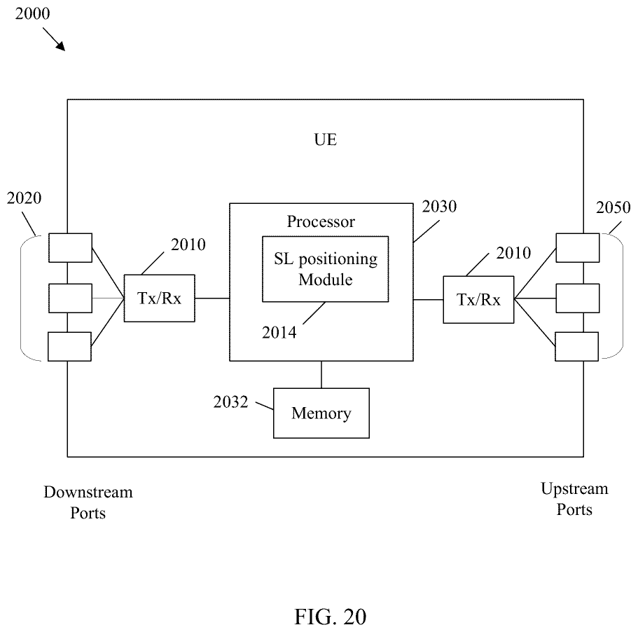

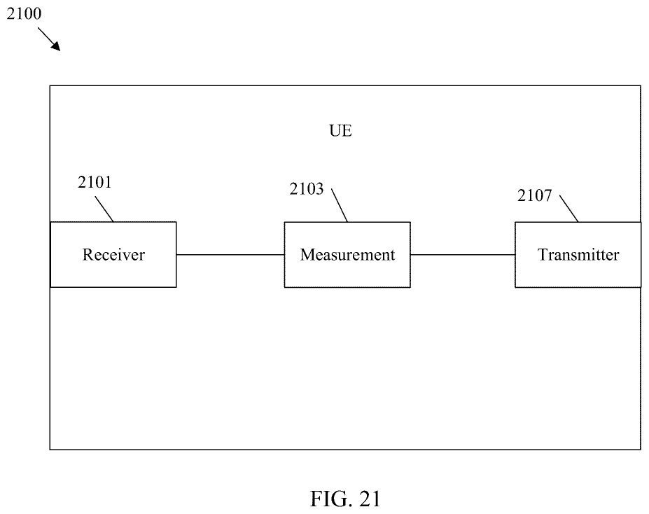

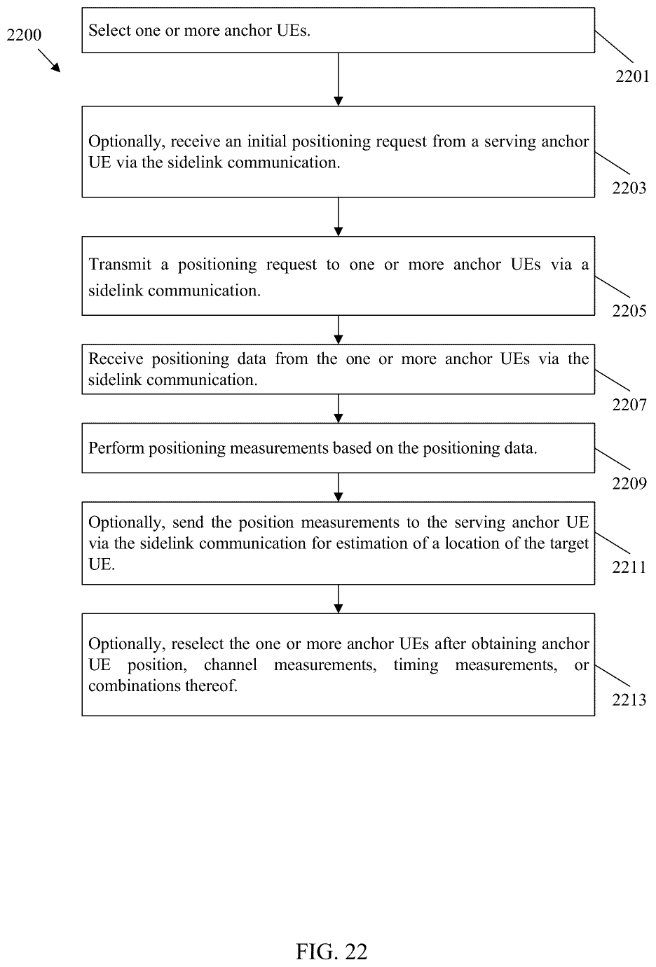

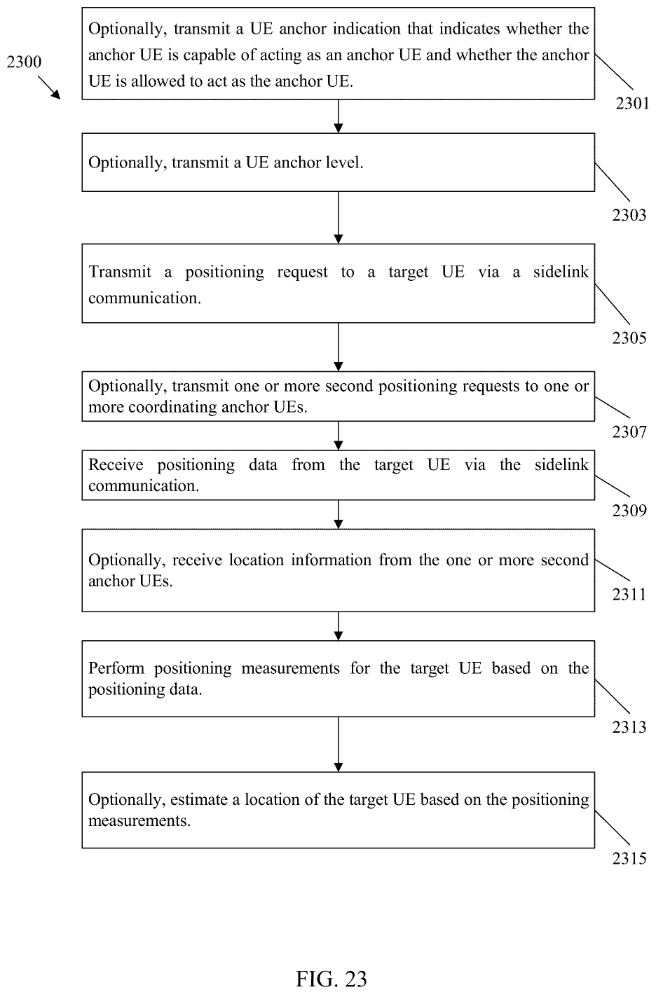

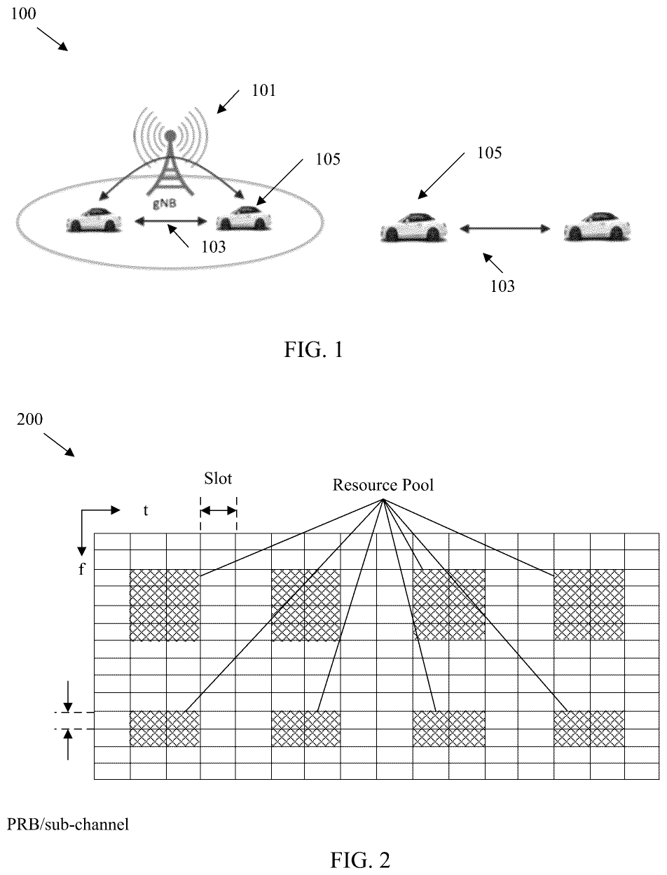

FIG. 2 is a schematic diagram of an example resource pool 200 in a resource grid for sidelink communications. A resource pool 200 is a set of resources that can be used for sidelink communication. Resources in a resource pool 200 are configured for different channels including control channels, shared channels, feedback channels, synchronization signals, reference signals, broadcast channels (e.g. master information block), and so on.

A resource pool 200 for sidelink can be configured in units of slots in the time domain and physical resource blocks (PRBs) or sub-channels in the frequency domain. A sub-channel comprises one or more PRBs. FIG. 2 illustrates an example of a resource pool 200 in the time-frequency resource grid.

For NR mobile broadband (MBB), each PRB in the grid is defined as a slot of 14 consecutive orthogonal frequency division multiplexing (OFDM) symbols in the time domain and 12 consecutive subcarriers in the frequency domain. Accordingly, each resource block contains 12×14 resource elements (REs). When used as a frequency-domain unit, a PRB is 12 consecutive subcarriers. There are 14 symbols in a slot when a normal cyclic prefix (CP) is used and 12 symbols in a slot when an extended cyclic prefix (ECP) is used. The duration of a symbol is inversely proportional to the subcarrier spacing (SCS). For a {15, 30, 60, 120} kilohertz (kHz) SCS, the duration of a slot is {1, 0.5, 0.25, 0.125} milliseconds (ms), respectively. Each PRB may be allocated to combinations of a control channel (CCH), a shared channel (SCH), a feedback channel, reference signals (RS), and so on. In addition, some REs of a PRB may be reserved. A communication resource may occupy a PRB, a set of PRBs, and use a code (if code division multiple access (CDMA) is used as in physical uplink control channel (PUCCH)), a physical sequence, a set of REs, and so on.

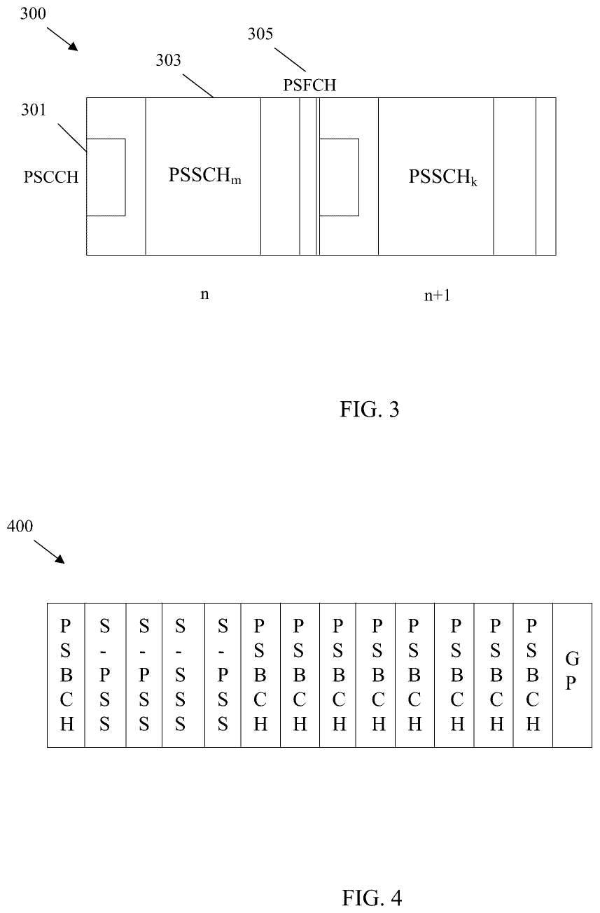

FIG. 3 is a schematic diagram of an example resource grid 300 with PSCCH 301, PSSCH 303, and PSFCH 305 resources. The PSCCH 301 carries the sidelink control information (SCI). The source UE uses the SCI to schedule the transmission of data on the PSSCH 303. The SCI can convey the time and frequency resources of the PSSCH 303, parameters for hybrid automatic repeat request (HARQ) process, such as the redundancy version, process identifier (id), new data indicator, and resources for the PFSCH 305. The PFSCH 305 can carry an indication, such as a HarQ acknowledgement (HARQ-ACK), of whether the recipient/destination UE decoded the payload carried on PSSCH 303 correctly (e.g. an acknowledgement (ACK) or negative acknowledgement (NACK). The SCI can also carry a bit field indicating a representation of the identity of the source UE. In addition, the SCI can also carry a bit field indicating a representation of the identity of the destination UE(s). Other fields include the modulation coding scheme (MCS) used to encode the payload and modulate the coded payload bits; the demodulation reference signal (DMRS) pattern, the antenna ports, and priority of the payload (transmission).

The NR sidelink control information (SCI), can be transmitted in a first stage SCI and a second stage SCI. The first stage SCI uses SCI Format 1-A. The second stage uses SCI Format 2-A, SCI Format 2-B, or SCI Format 2-C. The first stage SCI indicates the resources for the second stage SCI.

SCI format 1-A is used for the scheduling of PSSCH and 2nd-stage-SCI on PSSCH. The following information is transmitted by using the SCI format 1-A:
Priority—3 bits
Frequency resource assignment—

$$⌈ {log}_{2} ( \frac{{N}_{subChannel}^{SL} ( {N}_{subChannel}^{SL} + 1 )}{2} ) ⌉$$

bits when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits when the value of the higher layer parameter sl-MaxNumPerReserve is configured to 3.
Time resource assignment—5 bits when the value of the higher layer parameter sl-MaxNumPerReserve is configured to 2; otherwise 9 bits when the value of the higher layer parameter sl-MaxNumPerReserve is configured to 3.
Resource reservation period-┌log₂ Nₚₐₜₜₑᵣₙ┐ bits, where N_{rsv_period} is the number of entries in the higher layer parameter sl-ResourceReservePeriodList, if higher layer parameter sl-MultiReserveResource is configured; 0 bit otherwise.
DMRS pattern—┌log₂ Nₚₐₜₜₑᵣₙ┐ bits, where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured.
2nd-stage SCI format—2 bits.
Beta_offset indicator—2 bits as provided by higher layer parameter sl-BetaOffsets2ndSCI.
Number of DMRS port—1 bit.
Modulation and coding scheme—5 bits.
Additional MCS table indicator —: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit if higher layer parameter sl-PSFCH-Period=2 or 4; 0 bit otherwise.
Reserved—a number of bits as determined by higher layer parameter sl-NumReservedBits, with value set to zero.

SCI format 2-A is used for the decoding of PSSCH, with HARQ operation when HARQ-ACK information includes ACK or NACK, or when there is no feedback of HARQ-ACK information. The following information is transmitted by means of the SCI format 2-A:
HARQ process number—┌log₂ N_{process}┐.
New data indicator—1 bit.
Redundancy version—2 bits.
Source ID—8 bits.
Destination ID—16 bits.
HARQ feedback enabled/disabled indicator—1 bit.
Cast type indicator—2 bits as defined in Table 8.4.1.1-1.
CSI request—1 bit.

TABLE 8.4.1.1-1
Cast type indicator

| Value of Cast type | |
|---|---|
| indicator | Cast type |
| 00 | Broadcast |
| 01 | Groupcast |
| 10 | Unicast |
| 11 | Reserved |

SCI format 2-B is used for the decoding of PSSCH, with HARQ operation when HARQ-ACK information includes only NACK, or when there is no feedback of HARQ-ACK information. The following information is transmitted by means of the SCI format 2-B:
HARQ process number—┌log₂ N_{process}┐ bits.
New data indicator—1 bit.
Redundancy version—2 bits.
Source ID—8 bits.
Destination ID—16 bits.
HARQ feedback enabled/disabled indicator—1 bit.
Zone ID—12 bits.
Communication range requirement—4 bits.

SCI format 2-C is used for the decoding of PSSCH, and providing inter-UE coordination information or requesting inter-UE coordination information. The following information is transmitted by means of the SCI format 2-C:
HARQ process number—4 bits
New data indicator—1 bit
Redundancy version—2 bits.
Source ID—8 bits.
Destination ID—16 bits.
HARQ feedback enabled/disabled indicator—1 bit.
CSI request—1 bit.
Providing/Requesting indicator—1 bit, where value 0 indicates SCI format 2-C is used for providing inter-UE coordination information and value 1 indicates SCI format 2-C is used for requesting inter-UE coordination information

### Higher Layer Messages

SL-PSCCH-Config-r16 ::= SEQUENCE {
sl-TimeResourcePSCCH-r16 ENUMERATED {n2, n3} OPTIONAL, -- Need M
sl-FreqResourcePSCCH-r16 ENUMERATED {n10,n12, n15, n20, n25} OPTIONAL, -- Need M
sl-DMRS-ScrambleID-r16 INTEGER (0..65535) OPTIONAL, -- Need M
sl-NumReservedBits-r16 INTEGER (2..4) OPTIONAL, -- Need M
...
}

SL-PSCCH field descriptions

sl-FreqResourcePSCCH
Indicates the number of PRBs for PSCCH in a resource pool where
it is not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

If the ‘Providing/Requesting indicator’ field is set to 0, all the remaining fields are set as follows:
Resource combinations—

$$2 \cdot ( ⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ + 9 + Y ) bits ,$$

where
   Y=┌log₂ N_{rsv_period}┐ and N_{rsv_period} is the number of entries in the higher layer parameter sl-ResourceReservePeriodList, if higher layer parameter sl-MultiReserveResource is configured; Y=0 otherwise
   N_{subChannel}^{SL} is the number of subchannels in a resource pool provided by the higher layer parameter sl-NumSubchannel
First resource location—8 bits.
Reference slot location—(10+┌log₂(10·2^{μ})┐) bits.
Resource set type—1 bit, where value 0 indicates preferred resource set and value 1 indicates non-preferred resource set.
Lowest subChannel indices—2·┌log₂ N_{subChannel}^{SL}┐ bits.

If the ‘Providing/Requesting indicator’ field is set to 1, all the remaining fields are set as follows:
Priority—3 bits. Value ‘000’ of Priority field corresponds to priority value ‘1’, value ‘001’ of Priority field corresponds to priority value ‘2’, and so on.
Number of subchannels—┌log₂ N_{subChannel}^{SL}┐ bits.
Resource reservation period—┌log₂ N_{rsv_period}┐ bits, where N_{rsv_period} is the number of entries in the higher layer parameter sl-ResourceReservePeriodList, if higher layer parameter sl-MultiReserveResource is configured; 0 bit otherwise.
Resource selection window location—2·(10+┌log₂(10·2^{μ})┐) bits.
Resource set type—1 bit, where value 0 indicates a request for inter-UE coordination information providing preferred resource set and value 1 indicates a request for inter-UE coordination information providing non-preferred resource set, if higher layer parameter determineResourceSetTypeSchemel is configured to ‘UE-B's request’; otherwise, 0 bit.
Padding bits.

Sidelink inter-UE coordination (IUC) is specified to improve mode 2 reliability by overcoming issues such as hidden-node, exposed-node, and half-duplex, that impact sidelink performance. In particular, two IUC schemes are defined, i.e.,
Scheme 1: inter-UE coordination information signalling from UE-A to UE-B
   Set of resources preferred for UE-B's transmission
   Set of resources non-preferred for UE-B's transmission
Scheme 2: inter-UE coordination information signalling from UE-A to UE-B
   Presence of expected/potential resource conflict on the resources indicated by UE-B's SCI

In IUC Scheme 1, two IUC triggering scenarios are considered and specified. These include 1) Coordination triggered by an explicit request where UE-B sends explicit request to UE-A and UE-A, upon request, generates and sends the coordination information (preferred resource set or non-preferred resource set to UE-B); and 2) Coordination triggered by a condition other than an explicit request where a UE (UE-A) that satisfies certain condition(s) generates and sends coordination information to UE-B.

The conditions for the two IUC triggering scenarios are also specified. For IUC triggered by an explicit request, one of the two conditions is configured for the resource pool level. These include alt 1-up to UE-B's implementation and alt 2—the request can be triggered only when UE-B has data to be transmitted to UE-A. Similarly, for IUC triggered by a condition, two conditions are employed with one of them enabled by resource pool level (pre-)configuration. These include alt 1—up to UE-A's implementation, and alt 2—the coordination can be triggered only when UE-A has data to be transmitted together with coordination information to UE-B.

The criteria for generating the coordination information, where preferred resource set and non-preferred resource set are defined as follows:
Preferred resource set:
   Condition 1-A-1: Resource(s) excluding the overlapped reserved resource(s) of other UE with reference signal received power (RSRP) larger than a threshold.
   Condition 1-A-2: Resource(s) excluding the slots when UE-A, as Rx of UE-B, does not expect to perform SL reception from UE-B.
Non-preferred resource set:
   Condition 1-B-1: Reserved resource(s) of other UE identified by and RSRP measurement.
      Option 1: Reserved resource(s) of other UE(s) identified by UE-A whose RSRP measurement is larger than a (pre)configured RSRP threshold.
      Option 2: Reserved resource(s) of other UE identified by UE-A whose RSRP measurement is smaller than a (pre)configured RSRP threshold when UE-A is a destination of a TB transmitted by the UE(s).
   Condition 1-B-2: Resource(s) (e.g., slot(s)) where UE-A, when it is intended receiver of UE-B, does not expect to perform SL reception from UE-B.

To send an explicit request and coordination information, a medium access control protocol (MAC) explicit request and coordination information (MAC-CE) is used as the container. If configured, the 2nd stage SCI (SCI-2C) is also used for explicit request or coordination information.

For coordination triggered by an explicit request, only unicast is supported for both transmissions of explicit request and coordination information. For coordination triggered by a condition, unicast is supported for transmission of both types of coordination information. Broadcast and groupcast are supported for non-preferred resource set only.

The coordination information and explicit request can be transmitted multiplexed with data only if source/destination ID pair is the same.

FIG. 4 is a schematic diagram of an example structure of a S-SSB block 400. A synchronization slot in sidelink is denoted as a S-SSB 400 and is specified for one UE to synchronize with another UE. As shown in FIG. 4, the first OFDM symbol is for PSBCH. But like the regular sidelink slot, the first symbol is used for the settling of the automatic gain control (AGC). After which, there are two symbols for S-PSS and two for the S-SSS. Eight of the remaining nine symbols are for PSBCH transmission. The last symbol is guard period (GP) as in the regular sidelink slot. The PSBCH carries the SL master information block (SL-MIB).

In the frequency domain, the S-SSB occupies 11 PRBs with total 132 subcarriers. PSBCH occupies all 11 PRBs while the size of synchronization signal is 127 thus S-PSS and S-SSS occupy 127 subcarriers. The periodicity of S-SSB is 160 ms. The frequency location of the S-SSB is pre-configured. The number of S-SSB transmissions is set to 1 for FR1 and is configurable for FR2.

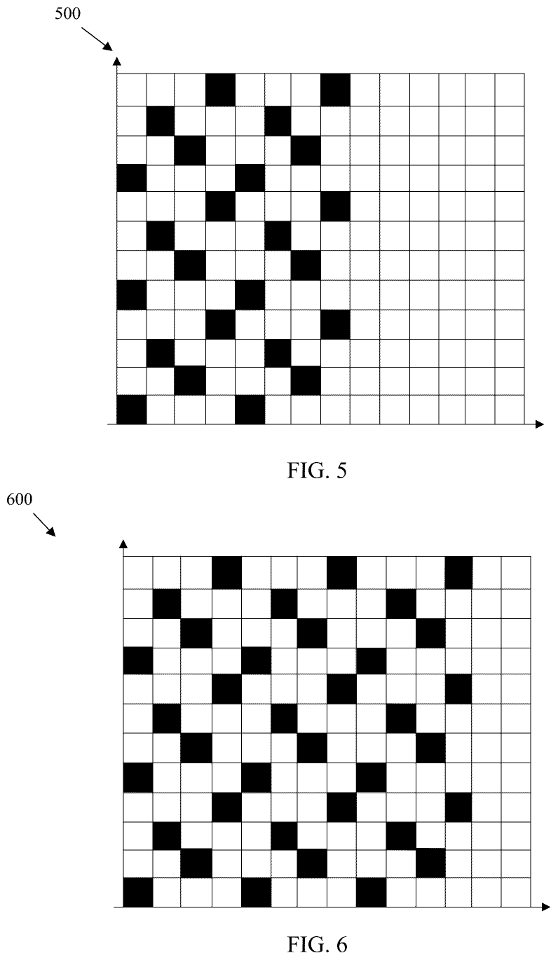

FIG. 5 is a schematic diagram of an example UL SRS 500. In NR an SRS resource with 1, 2, or 4 antenna ports is supported which can be mapped to N_{symb}^{SRS}∈{1,2,4,8,12} consecutive OFDM symbols. Combined transmission on every K_{TC}=2 or 4 or 8 REs in the frequency domain is supported. In addition, cyclic shift is supported with the maximum number of cyclic shifts, n_{SRS}^{cs,max}, equal to 8, 12, and 6 when size of comb is 2, 4, and 8, respectively. An SRS sequence ID is configured by higher layer parameter. The starting OFDM symbol l₀ in the time domain is defined by an offset l_{offset} from the end of the slot, where l_{offset} ∈{0,1, . . . ,13} indicates the starting position can be any OFDM symbol in the slot. The frequency starting position is also specified. For positioning, an additional offset in frequency domain k_{offset}^{l′} is specified which is also dependent of the OFDM symbol configured for SRS transmissions. An SRS resource may be configured for periodic, semi-persistent, or aperiodic SRS transmission. In the frequency domain, SRS allocation is aligned with the 4 PRB grid. Frequency hopping is supported as in the case of long-term evolution (LTE). NR SRS bandwidth and hopping configuration are designed to cover a larger span of values compared to that of LTE.

An SRS resource is configured by the SRS-Resource IE for UL channel sounding or the SRS-PosResource IE for positioning purposes. The UE can be configured with one or more SRS resource sets. For each SRS resource set, a UE may be configured with a number of SRS resources. The use case for an SRS resource set is configured by the higher layer parameter. Such use cases may include beam management, codebook-based uplink MIMO, and non-codebook-based uplink multiple input multiple output (MIMO), and antenna switching, which actually is for general downlink CSI acquisition.

In the time domain at slot level, an SRS resource can be configured periodically with a periodicity in slots (T_{SRS}) and slot offset (T_{offset}).

TABLE 6.4.1.4.2-1
Maximum number of cyclic shifts n_{SRS}^{cs, max}
as a function of K_{TC}. (TS 38.211)

| KTC | n_{SRS}^{cs, max} |
|---|---|
| 2 | 8 |
| 4 | 12 |
| 8 | 6 |

TABLE 6.4.1.4.3-2
The offset k_{offset}^{l′} for SRS as a function of K_{TC} and l′.

| | k_{offset}⁰, . . . , k_{offset}^{N}^{_{symb}}^{SRS}−1 | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

FIG. 6 is a schematic diagram of an example DL-PRS 600. PRS is the downlink reference signal for positioning purposes. PRS is also called DL-PRS 600 while the SRS configured for positioning is sometimes called UL-PRS 500.

DL-PRS 600 is specified with a starting symbol lₛₜₐᵣₜ^{PRS}∈{0, . . . ,12}, the size (number of OFDM symbols) of PRS L_{PRS} E {2,4,6,12}, the frequency domain interval of two DL-PRS resource-elements (the comb size) K_{comb}^{PRS} ∈{2, 4, 6,12} which is selected from a specified subset of {L_{PRS}, K_{comb}^{PRS}} combinations, the initial frequency domain offset k_{offset}^{PRS} ∈{0,1, . . . , K_{comb}^{PRS}−1}, and, similarly as the UL-SRS for positioning, an additional frequency domain offset k′ specified in a table (Table 7.4.1.7.3-1) which varies over OFDM symbol to symbol.

TABLE 7.4.1.7.3-1
The frequency offset k′ as a function of l − lₛₜₐᵣₜ^{PRS}.

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In the time domain at the slot level, DL-PRS 600 can be configured with a periodicity Tₚₑᵣ^{PRS} ∈2^{μ}{4, 5,8, 10, 16, 20, 32, 40, 64, 80, 160, 320,640, 1280, 2560, 5120, 10240} and a slot offset T_{offset}^{PRS}∈{0,1, . . . , Tₚᵣₑ^{PRS}−1}, as well as an additional slot offset T_{offset}^{PRS}. The bandwidth of the DL-PRS can be configured in a range from 24 to 275 PRBs with a step of 4 PRBs.

There is a need for 3GPP based sidelink positioning solutions. Various use cases can benefit from the SL positioning, such as vehicle to everything (V2x) and public safety use cases, ranging-based services, and industrial internet of things (IIoT) use cases.

A study item on expanded and improved NR positioning includes an objective of SL positioning as:
Study and evaluate performance and feasibility of potential solutions for SL positioning, considering relative positioning, ranging and absolute positioning: [RAN1, RAN2]
   Evaluate bandwidth requirement needed to meet the identified accuracy requirements [RAN1]
   Study of positioning methods (e.g. TDOA, RTT, AOA/D, etc) including combination of SL positioning measurements with other RAT dependent positioning measurements (e.g. Uu based measurements) [RAN1]
   Study of sidelink reference signals for positioning purposes from physical layer perspective, including signal design, resource allocation, measurements, associated procedures, etc, reusing existing reference signals, procedures, etc from sidelink communication and from positioning as much as possible [RAN1]
   Study of positioning architecture and signalling procedures (e.g. configuration, measurement reporting, etc) to enable sidelink positioning covering both UE based and network based positioning [RAN2, including coordination and alignment with RAN3 and SA2 as required]

Sidelink Resource Allocation is now discussed. In NR V2X sidelink mode 1, the gNB performs scheduling of the sidelink. Accordingly, the gNB allocates the SL resources for SL communications, and the resource allocation is sent to the UE through the NR Universal mobile telecommunications system terrestrial radio access network (UTRAN) to UE (Uu) interface. Therefore, sidelink mode 1 is applicable to UEs under the coverage of a gNB. The resources allocated with mode 1 can be either on the same carrier as cellular NR or a dedicated sidelink carrier.

There are three types of mode 1 resource allocations. They include dynamic assignment, type 1 configured grant (CG), and type 2 configured grant. In dynamic assignment, the UE first sends a scheduling request (SR) for every TB to the gNB via the PUCCH. Then gNB sends a SL resource allocation to the UE via downlink control information (DCI) format 3_0 over the physical downlink control channel (PDCCH). In CG based resource allocation, UE first sends a message to the gNB with the expected SL traffic, including periodicity, the traffic bandwidth (TB) maximum size, and quality of service (QoS) information. The gNB provides resource allocation. The gNB uses radio resource control (RRC) signaling to provide a CG to the UE. In type 1 CG, the UE can use the resource allocation immediately. In type 2 CG, the UE uses the allocated resources after activated by gNB via a DCI.

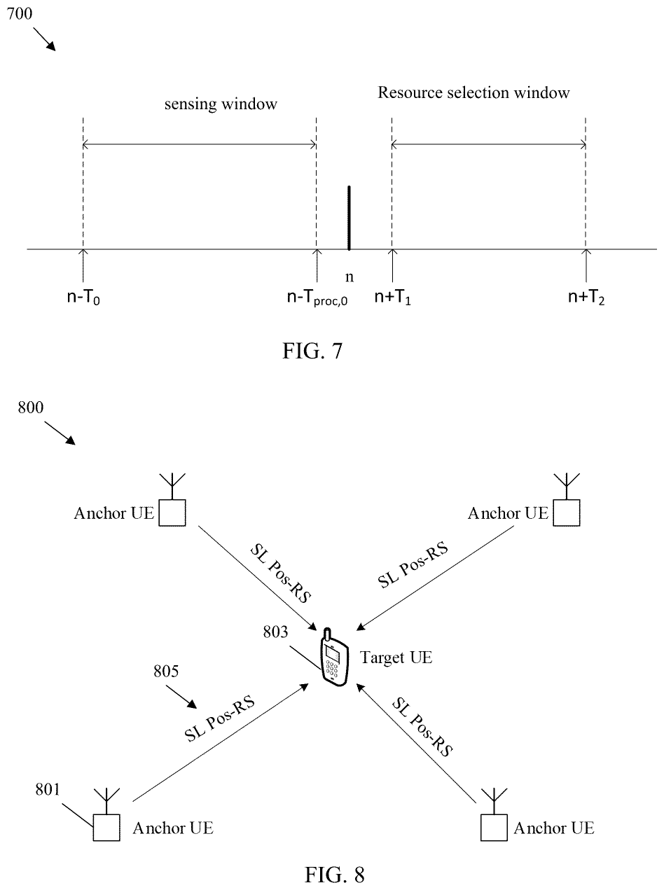

FIG. 7 is a schematic diagram of an example sensing and resource selection window 700. In sidelink mode 2, the UEs transmits and receives information without the need of the network management. UEs themselves allocate the resources from a resource pool for sidelink transmissions. Resource allocation relies on a sensing and reservation process as shown in FIG. 7. During the sensing procedure, a monitoring UE detects SCI transmitted in each slot in the sensing window and measures the RSRP of the resource indicated in the SC. A monitoring UE may also receive transmissions of data, and hence may also be a receiving UE. For periodic traffic, a resource reservation for sidelink transmissions can be used. When a UE occupies a resource on slot sₖ, the UE will also occupy the resource on slot sₖ+q*RRIₖ where q is an integer, and RRIₖ is a resource reservation interval for UE m that the sensing UE detected. Detecting the SCI includes the steps of receiving and decoding the PSCCH and processing the SCI within the PSCCH.

For aperiodic or dynamic transmissions, the transmitting UE reserves multiple resources and indicates the next resource in the SC. Therefore, based on the sensing results, a monitoring UE can determine which resources may be occupied in the future and can avoid them for its own transmission if the measured RSRP on the occupied resource during the sensing period is above the RSRP threshold in the resource exclusion procedure.

FIG. 7 shows the timing information on the sensing and resource selection for NR sidelink transmission, which is referred to as full sensing. When resource selection is triggered on slot n, based on sensing results in the sensing window, on slots [n-T₀, n-T_{proc,0}], the transmitting UE selects the resources in the resource selection window in a resource pool, on slots [n+T₁, n+T₂], where
T₀: number of slots with the value determined by resource pool configuration;
T_{proc,0}: time required for a UE to complete the sensing process;
T₁: processing time required for identification of candidate resources and resource selection T₁≤T_{proc,1};
T₂: the last slot of resource pool for resource selection which is left to UE implementation but in the range of [T_{2 min}, PDB] where T_{2 min} is minimum value of T₂ and PDB denotes packet delay budget, the remaining time for UE transmitting the data packet; and
T_{proc,1}: maximum time required for a UE to identify candidate resources and select new sidelink resources.

Several NP positioning methods can be used. NR Positioning methods include DL-based solutions, UL-based solutions, and DL- and UL-based solutions.

DL-based solutions are now discussed. A timing based technique known as Downlink Time Difference of Arrival (DL-TDOA) can be used. Similar to Observed Time Difference Of Arrival (OTDOA) in LTE, NR specified DL-TDOA positioning measures the timing difference of DL-PRS on line of sight (LOS) paths from different gNBs. Downlink angle(s) of departure (DL-AOD) is an example of an angle based positioning technique used by UEs. In DL-AOD, the UE measures the received power based on DL-PRS and estimates the angle(s) of departure (AOD) from different gNBs based on the measured power difference among PRS and/or beams from the same transmission and reception point (TRP).

UL-based solutions are now discussed. Uplink Time Difference of Arrival (UL-TDOA) is an example timing based technique. NR introduces an UL positioning technique using an UL positioning signal which is configured using an UL SRS. gNBs measure the UL timing difference from the UE. Uplink angle(s) of arrival (UL-AOA) is an example angle based technique. Similar to DL-AOD, gNBs measures the AOA from the UE using the UL SRS configured for positioning purposes. gNBs measure both zenith AOA and azimuth AOA to obtain a three-dimensional (3D) location.

DL- and UL-based solutions are now discussed. Multi-cell round trip time (multi-RTT) is an example timing based technique. In multi-RTT, the UE measures the UE reception to transmission (Rx-Tx) time difference and the gNBs measure the gNB Rx-Tx time difference. The round trip time (RTT) can be estimated with two Rx-Tx time differences for each UE-gNB pair. For Rx-Tx time difference measurement, DL PRS and UL SRS are configured and transmitted from gNBs and the UE, respectively. Enhanced Cell-ID (E-CID) is a positioning technique based on radio resource management (RRM) measurements, such as RSRP and resource signal received quality (RSRQ), via synchronization signals, such as SSB measurements and channel state information reference signal (CSI-RS). UL AOA is also supported

The positioning method selection, configuration of the reference signals (SRS, PRS) and collection of the measurements is orchestrated by the Location Management Function (LMF) that resides in the network. The LMF manages the support of different location services for target UEs, including positioning of UEs and delivery of assistance data to UEs. The LMF may interact with the serving gNB or serving ng-eNB for a target UE to obtain position measurements for the UE. Such position measurements include uplink measurements made by a next generation radio access network (NG-RAN) and downlink measurements made by the UE that were provided to an NG-RAN as part of other functions such as for support of handover.

FIG. 8 is a schematic diagram illustrating sidelink positioning 800. Radio access technology (RAT) dependent positioning in cellular systems employ various procedures. For NR positioning, the functions and procedures are similar to procedures used in LTE. Some techniques and UL reference signals are introduced for NR. However, for SL positioning the procedures and the reference signaling are not defined yet.

As illustrated in FIG. 8, a sidelink positioning 800 system may comprise multiple location reference UEs denoted as anchor UEs 801 and a target UE 803. Sidelink positioning 800 obtains the position of the target UE 803 based on the location information of the anchor UEs 801 through reference signal measurements exchanged between the target UE 803 and anchor UEs 801. The reference signaling for SL positioning measurements is denoted as SL positioning reference signals (SL Pos-RS) 805.

In the NR positioning, DL and UL positioning signaling are well synchronized and organized. The network can provide the configurations of the signaling for positioning, such as DL PRS or UL SRS, and measurement reporting. Unlike NR Uu link, sidelink transmissions are opportunistic, and multiple transceiver links co-exist in the same resource pool. To minimize the effects of resource allocation conflicts between different UE-to-UE links which incurs interference, sidelink transmissions are based on resource reservations either through gNB with centralized planning under gNB's coverage (Mode 1) or through UE sensing for Mode 2. Therefore, the positioning procedure and resource allocations are different in sidelink. In this document, a procedure and/or protocol design is provided for SL positioning as well as reference signal configurations.

Disclosed herein is a mechanism for initiating sidelink positioning between an anchor UE and a target UE. Sidelink positioning is a mechanism that allows either an anchor UE or a target UE to determine the location of the target UE relative to the anchor UE via a sidelink communication between the target UE and the anchor UE, for example without direct interaction by a corresponding 5G network. Anchor UE(s) can indicate each UE's willingness and capabilities to act as an anchor UE via signaling. The target UE can then select one or more anchor UEs. The target UE and the anchor UE can reserve time and frequency communication resources for signaling via opportunistic mechanisms or via assignment by a 5G network. A positioning request is then sent. The request can be sent by the target UE to one or more anchor UEs. In another example, the request can be sent by an anchor UE to the target UE. In another example, an anchor UE can act as a serving anchor UE and can send a request to the target UE and to coordinating anchor UEs or to the target UE for further communication to the coordinating anchor UEs. Upon receiving a request, an anchor UE responds with position information. In an example, the request is triggered by conditions. In other examples, the position information is sent based on conditions without a request. Once the position information has been sent, the target UE can either measure the location of the target UE or send the position information back to an anchor UE, such as a serving anchor UE, to allow the anchor UE to measure the location of the target UE. Position information from coordinating UEs can also be sent to a serving anchor UE, either directly or via target UE. By using one or more of these mechanisms, an exchange of position information is triggered via a sidelink communication (e.g., directly between the UEs without interaction by the 5G network.) The UEs can then determine the position of the target UE by measurements made on the position information without the need to rely on location systems in the 5G network. As such, the present mechanisms cause UEs to perform beneficial functions, such as allowing UEs (e.g. vehicles) to determine their position even when outside the range of network coverage.

SL Pos-RS and the exchange of the positioning information and measurement reports require SL resources. To achieve a certain accuracy for positioning, sufficient bandwidth for SL Pos-RS should be allocated, particularly for timing-based positioning techniques. Therefore, SL positioning should be on-demand or an as-needed based process. Otherwise, the resource pool becomes overwhelmed by unnecessary transmission of reference signals and information exchange, which increases the system load and incurs a large amount of resource collisions.

Also, sidelink inter-UE coordination is specified to reduce potential resource conflicts. In coordination Scheme 1, a UE (UE-A) provides the coordination information, e.g., preferred resource set or non-preferred resource set, to help the other UE (UE-B) select appropriate resources for its transmissions. The coordination can be triggered with an explicit request from UE-B or when a certain condition is met at UE-A.

The following are example designs of a sidelink positioning system that can be triggered with a request or a condition.

Six positioning methods are adopted for NR RAT dependent positioning solutions, namely, DL-TDOA, DL-AOD, UL-TDOA, UL-AOA, multi-RTT, and E-CID. For sidelink communications, timing based techniques can also be applied. Since there is no DL or UL, sidelink DL-TDOA and UL-TDOA techniques can be generalized as SL Time Difference of Arrival (SL-TDOA). However, as illustrated in FIG. 8, the position of the target UE can be requested and estimated at either target UE 803 and anchor UEs 801. Additional procedures are described as the information exchange and positioning signal are in different directions.

Multi-RTT is also an efficient positioning technique to consider for the sidelink. Since multi-RTT based positioning does not need synchronization, multi-RTT based position can facilitate sidelink positioning given that synchronization is not required among the anchor UEs.

E-CID is a positioning method which only requires signal strength measurements, e.g., RSRP and RSRQ. For the sidelink, a procedure based on RSRP measurement can be specified for SL positioning. For description purposes, we denote this sidelink positioning technique as Enhanced Sidelink-ID (E-SID).

For angle-based techniques, the measurements and estimation of angles, i.e., AOD and AOA, may not be accurate enough for positioning since there are at most two antenna ports supported in the sidelink. While angle-based positioning techniques may be associated with certain drawbacks in sidelink based on existing specification support for the number of antenna ports, the design of positioning procedures or protocols, and the positioning signaling can be applied to angle-based positioning techniques as well.

Sidelink positioning procedures are now discussed. First, an indication of anchor UEs 801 is discussed. Anchor UEs 801 serve as reference UEs with known locations. A UE which supports sidelink positioning and capable of being an anchor UE 801 for a location function can be an anchor UE 801. Since there may be multiple positioning techniques, an anchor UE may support one or multiple positioning techniques. The target UE 803 may request the positioning reference signaling, location information, or measurements from the anchor UEs 801. In one embodiment, an anchor UE 801 (or positioning reference UE) signals another UE that it can be an anchor UE 801.

If a UE is capable of being an anchor UE 801, the UE may not always want to serve as an anchor UE 801. For example, the UE may not meet a certain condition to be an anchor UE 801. Therefore, an indication of anchor UEs 801 may be employed. For example, a UE may indicate via periodic, semi-static, or dynamic signaling whether it can be an anchor UE 801 for sidelink positioning. For better positioning accuracy, the target UE 803 may synchronize with anchor UEs 801. However, this is not necessary for some positioning methods such as multi-RTT. The SL synchronization can be achieved via S-SSB. Since S-SSB is sent periodically, a UE can indicate that it can be an anchor UE 801 or its availability for positioning as an anchor UE 801 via one or more reserved bits in a SL-MIB carried in a PSBCH transmitted in a S-SSB. For instance, one reserved bit in SL-MIB in S-SSB may indicate whether the UE can be an anchor UE 801. Here the indication can be used to indicate both cases, included whether the UE is capable of being an anchor UE and whether the UE is willing to be an anchor UE. The valid duration of the indication in S-SSB can be a S-SSB transmission period, such as 160 ms, some other specified value, such as before the next S-SSB transmission, or a configured or pre-configured value. Alternatively, for more dynamic indication, the UE can use a reserved bit in SCI format 1-A. The indication can also be provided through RRC signaling.

The anchor indication can be enabled/disabled by (pre-)configuration, which is mostly for dynamic indications, such as using a reserved bit in S-SSB or PSCCH SCI-1A. The indication is in addition to signal exchange on the UE capabilities.

The anchor availability indication and the support of specific positioning methods/techniques may be indicated in various ways. For instance, the anchor indication can be available for all supported SL positioning techniques. Alternatively, it may be specified to a subset of positioning techniques, such as timing based and/or angle-based techniques. In E-SID positioning based on signal strength measurement (e.g., RSRP), a dynamic indication may not be employed. The capability signaling exchange of UE features between the target UE 803 and an anchor UE 801 may be used for signaling as described above. RTT based ranging or multi-RTT based positioning may use more signaling exchanges, such as Rx-Tx time difference measurement. The RTT based capability is different from the timing-based techniques. The indication can be different. There may be different indications for different positioning techniques. With separate indications, more bits should be specified. Examples of such indications may be bitmaps, entry of a table indication each combination, etc.

Sidelink positioning procedures and SL Pos-RS transmissions are now discussed. Positioning techniques employ the transmission of positioning reference signals. For a Uu link, the reference signal can be configured by the network and broadcasted to every UE connected to the network or a gNB. However, the reference signal in SL may need resource reservations. For example, the SL CSI-RS transmitted with PSSCH and CSI-RS is used only for unicast communications. For positioning, the sidelink Pos-RS transmissions may also need SL resource reservation even when there is no data to be transmitted. Since positioning requests may be on-demand, which may require a triggering either from the target UE or the anchor UE, this triggering procedure enhances the procedures used for inter-UE coordination. The procedures of sidelink positioning are discussed below, for example based on SL Pos-RS transmissions. The disclosure describes the scenario that the positioning estimation is at the target UE 803. The proposed design and solutions may also be applied to the scenario that the positioning estimation is performed at the anchor UE 801.

Triggering of Sidelink Pos-RS transmissions is now discussed. A UE-B may trigger the coordination by sending an explicit request to UE-A who will provide coordination information including a preferred resource set or a non-preferred resource set to UE-B for UE-B's resource selection. Coordination may also be triggered by a condition at UE-A. When the condition is met, UE-A generates and sends coordination information to UE-B. In SL positioning, either the target UE 803 or an anchor UE 801 can trigger the SL positioning process, which initiates the transmission of SL Pos-RS and the corresponding information exchange. The information exchange may include the location information of the anchor UEs 801 to the target UE 803 or the measurements at anchor UEs 801 to the anchor UE 801 that performs the location estimation of the target UEs 803. Several examples are presented below that trigger a Sidelink positioning process or specifically transmissions of SL Pos-RS signaling.

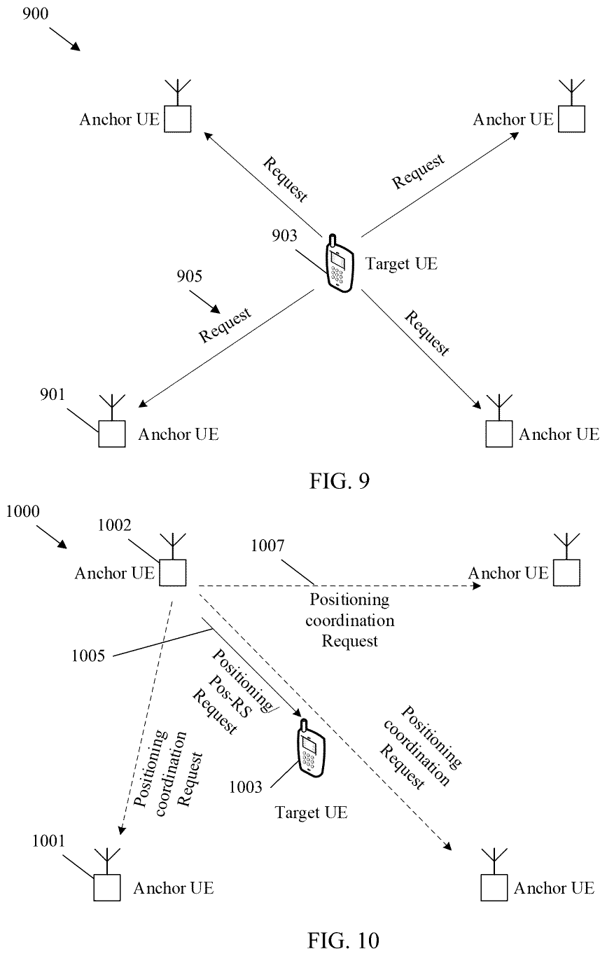

FIG. 9 is a schematic diagram illustrating sidelink positioning 900 triggered by a target UE 903. Sidelink positioning and the SL Pos-RS transmissions may be triggered by an explicit request 905. Depending on which device performs the positioning or the timing/angle measurements, the explicit request 905 can be sent from the target UE 903 or an anchor UE 901.

As shown in FIG. 9, when the target UE performs positioning or measurement, the target UE 903 may send an explicit request 905 for positioning and SL Pos-RS to the anchor UEs 901. With the indication of the presence of anchor UE 901, the target UE 903 may know the availability of anchor UEs 901 and select a set of UEs as the anchor UEs 901 for the target UE's 903 positioning request. Not all UEs indicated as anchor UEs 901 can be or need to be selected by the target UE 903. The selection may be based on certain criteria. To achieve a certain positioning reliability, the synchronization (sync) source of the anchor UE 901 may be important. A UE may have certain requirements on sync source or position accuracy allowing a UE to indicate whether the UE can be an anchor UE 901. A target UE 903 may have different or more stringent requirements for anchor UE 901 selection. In addition, the target UE 903 can select an anchor UE 901 based on the channel condition between the target UE 903 and the anchor UE 901. For example, the target UE 903 may select a UE with a clear dominant LOS channel path as the anchor UE 901. For example, for a multipath channel, the anchor UE 901 may be selected when there is one path substantially stronger than all others. The threshold for LOS determination may employ a power difference for paths comparison and may be configured to preconfigured. A non-LOS (NLOS) channel to the target UE 903 can introduce errors in the position determination and therefore the corresponding anchor UE 901 may be given lower priority in anchor selection.

FIG. 10 is a schematic diagram illustrating sidelink positioning 1000 triggered by an anchor UE 1002. In one example, an anchor UE may initiate the positioning process. An anchor UE may act as a serving anchor UE 1002, may send an explicit positioning request 1005 to the target UE 1003, and may request the transmission of SL Pos-RS. Meanwhile, the anchor UE 1002 may send different requests 1007 to other anchor UEs 1001 to coordinate measurements. Such other anchor UEs 1001 may also be referred to as coordinate anchor UEs. This is not necessary when only ranging between anchor UE 1002 and target UE 1003 is performed.

The request may be sent from the serving anchor UE 1002 to the target UE 1003 via one of the three alternative ways as presented above. The 1-bit triggering request can be used to initiate (pre-)configured S-SSB, SL CSI-RS transmissions, (pre-)configured SL PRS, or (pre-)configured SL SRS (as SL-Pos-RS) from the target UE 1003. The request via a 2nd stage SCI or MAC-CE can trigger the SL Pos-RS transmission at the target UE 1003 with some settings, such as signaling option, SL Pos-RS configurations, bandwidth, SL Pos-RS power control, etc. In this disclosure, the term anchor UE may be equivalent to the term anchor node since many devices, such as road side units (RSUs), may be used as anchors for position determination.

When location estimation is performed at a serving anchor UE 1002, the serving anchor UE 1002 may send the request to another anchor UE 1001. The anchor UE 1002 that needs to estimate the location of the target UE 1003 may send the request in the node's capacity as the serving anchor UE 1002.

Then the participating anchor UEs 1001 may send their locations to the serving anchor UE 1002 and also report their measurements to the serving anchor UE 1001. When the anchor UEs 1001 are UEs with fixed locations, such as RSUs, the location information may only be exchanged once, even when a UE indicates it cannot act as an anchor UE 1001 at the moment. For UEs with low mobility and slowly changing locations, the location information can be exchanged semi-statically, for example via direct communications interface (PC5) RRC. For UEs with quickly changing locations, the location information should be exchanged or updated to or from the serving anchor UEs 1002 dynamically or with a smaller periodicity. In one example, the periodicity of information exchange is related to the speed, or Doppler spread of the RS. For instance, when RS has a larger Doppler spread, frequent information exchange can be done. The exact mapping between Doppler values and periodicity may be (pre-)configured and provided with the positioning request 1005 and/or positioning coordination request 1007. For positioning accuracy, the location information should be obtained when the anchor UE 1001 performs the measurement, which should be sent to the serving anchor UE 1002 dynamically.

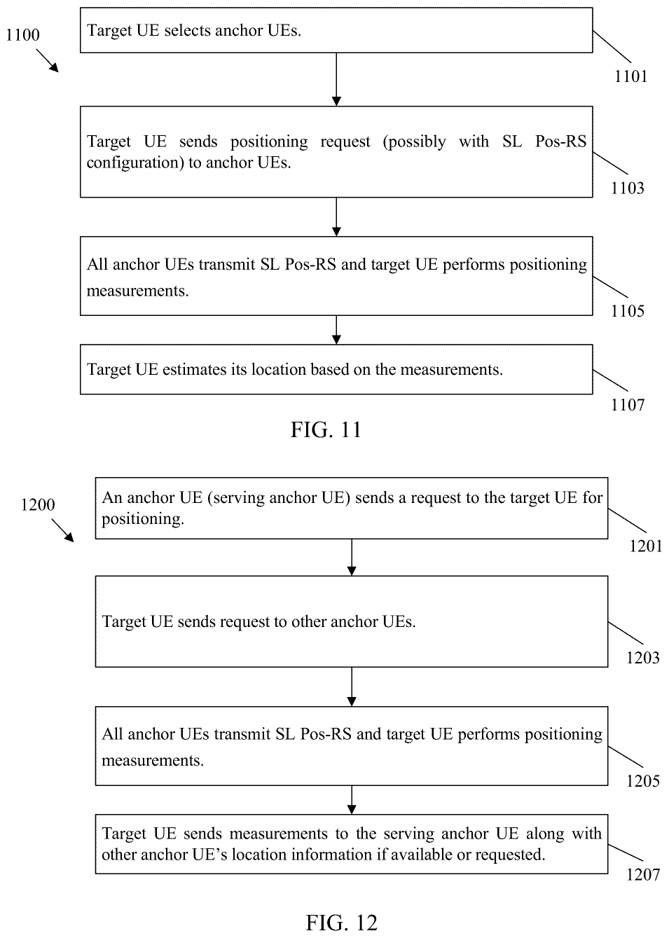

FIG. 11 is a flowchart of an example method 1100 for positioning at a target UE triggered by a request. The target UE selects one or more anchor UEs at step 1101. In one example, there is a metric (for instance a number between 0 and 1) to characterize the degree of LOS/NLOS for the channel. The selection of an anchor may be done by combining the RSRP of the positioning RS, with the LOS/NLOS metric, and other criteria (zone, reference synchronization, mobility indicator, speed, Doppler spread, etc.).

Once anchor UEs are selected, the target UE can send a positioning request to the anchor UE(s) at step 1103. The request can be simply a trigger via a one-bit indication. One reserved bit of the first stage SCI, e.g., SCI 1A, can be used for such indication, or one 1-bit in the 2nd stage SCI. The request can also be sent by a 2nd stage SCI to deliver more information, e.g., SL Pos-RS signaling option and/or configurations. In another example, the request can be sent by MAC-CE for more information including SL Pos-RS signaling option and/or configurations, and/or preferred resources for the SL Pos-RS transmissions. The request can be realized with RRC signaling.

The 1-bit triggering request can be used for S-SSB or SL CSI-RS transmissions, the SL PRS, or the SL SRS (as a SL Pos-RS) preconfigured by the anchor UE, default SL Pos-RS configuration, or semi-static RRC configurations at the anchor UE. For the 2nd stage, SCI or MAC-CE can be used as the container of the positioning request and can carry more bits. Accordingly, the SL Pos-RS signaling option, SL Pos-RS configurations, bandwidth, SL Pos-RS power control, etc. can be sent in the request.

The SL Pos-RS configuration can be dynamic or semi-static, and can be sent by the target UE in the request or via RRC signaling. The triggering can be dynamic or semi-static as well. In general, physical layer (PHY) signals, such as one-bit request, 2nd stage SCI, and MAC-CE, can be viewed as dynamic triggering, and RRC signaling is semi-static. A hybrid approach is that the configurations can be sent via RRC signaling or MAC-CE to the anchor UEs. When the target UE determines to estimate its location, the target UE sends an explicit request to the anchor UEs.

In a different example the triggering bit is sent by groupcast to a group of UEs. In addition to the triggering bit a response condition may be provided. A potential anchor node participates only if it satisfies the provided condition, such as conditions related to RSRP, synchronization source, zone ID, etc.

At step 1105, all the anchor UEs transmit SL Pos-RS signals in response to the positioning request sent at step 1103. The target UE can then perform a positioning measurement based on the SL Pos-RS signals. The target UE can then estimate its location based on the measurements at step 1107.

FIG. 12 is a flowchart of an example method 1200 for a hybrid procedure for positioning at an anchor UE. A hybrid mode is now described for positioning using an anchor UE. At step 1201, a serving anchor UE can send a request to the target UE. The target UE first sends the request to other coordinating anchor UEs at step 1203. The coordinating anchor UEs can then participate and transmit the SL Pos-RS to the target UE at step 1205. The target UE can perform a positioning measurement. The target UE then sends a measurement report to the serving anchor UE at step 1207. In some examples, the coordinating anchor UEs can send their location information directly to the serving anchor UE. In other examples, the coordinating anchor UEs send their location information to the target UE. The target UE then sends the location information of the coordinating anchors to the serving anchor UE at step 1207 along with measurement reports in one or separate transmissions.

Conditions for positioning triggered by an explicit request are now discussed. Certain conditions can be specified for either a target UE or an anchor UE to trigger the positioning process or simply the SL Pos-RS transmissions. The condition(s) for triggering the explicit request can be set as a resource pool level (pre-)configuration. One or more of the following alternatives can be enabled or disabled as the conditions for triggering the explicit request.

In one example, it is up to UE's implementation (either the target UE or the anchor UE) to trigger an explicit request. In another example, the request generation can be triggered by RSRP measurement(s) that is greater than a threshold. The RSRP measurement can be between the target UE and the serving anchor UE. In another example, the distance can trigger an explicit request. For example, the distance can be determined based on a Zone ID (e.g., contained in SCI format 2-B) indicating the target UE's own location and anchor UE's location and/or a change thereof. The center or edge of a zone can be estimated based on historical communication, for example based on the time the target UE stays in the same zone. In another example, the number of the possible anchor nodes can be greater than a threshold to trigger the explicit request. This condition indicates whether SL positioning is possible or the fundamental limitation on the positioning accuracy is satisfied. This may be a sufficient condition for SL positioning. It should be noted that these conditions are dependent of the positioning objective, e.g., absolute positioning or ranging. The condition relating to the number of possible anchor nodes relative to a threshold can be applied for positioning. For example, one anchor UE is enough to allow for ranging.

Sidelink positioning may also be triggered based on a condition other than an explicit request. For some scenarios, a UE may perform positioning regularly or when some conditions are met. Therefore, an anchor UE or the target UE may transmit the SL Pos-RS upon being triggered by a condition. One example is that in some areas, the RSUs may send a SL Pos-RS when the target UE appears or is within a certain range. Another example is for a cyber-physical control in smart factory. In some working areas or in order to perform a certain task, the target UE may need to estimate its location, or an anchor UE may need to estimate the position of the target UE. In these scenarios, a SL positioning procedure may not need to be triggered by a request. In addition, sidelink positioning can also be triggered by a condition. For sidelink positioning triggered by a condition, SL Pos-RS settings can be (pre)configured or determined by UE implementation. SL Pos-RS power control can be specified or determined by the UE who transmits SL Pos-RS.

Similar to the conditions for the SL positioning request, the conditions for SL Pos-RS transmissions can be (pre-)configured at the resource pool level which can enable and/or disable one or more conditions listed below.

In one example, it is up to UE's implementation (either the target UE or the anchor UE) which conditions trigger SL Pos-RS transmissions. In another example, the SL Pos-RS transmissions can be triggered by RSRP measurement(s) greater than a threshold. The RSRP measurement can be between the target UE and the serving anchor UE. In another example, distance can trigger SL Pos-RS transmissions. For example, distance can be determined based on Zone ID indicating the target UE's own location and anchor UE's location and/or a change thereof. In another example, the anchor UE may consider its position accuracy to be a critical condition for the anchor UE to be an anchor UE. The position accuracy may be determined based on a sync source used by the anchor UE. Accordingly, a changing position accuracy may trigger or disable SL Pos-RS transmissions. In another example, the channel condition between the anchor UE and the target UE may trigger or disable SL Pos-RS transmissions. The channel condition between the anchor UE and the target UE may be determined based on the LOS channel with dominant LOS path.

Once the enabling conditions are met, the anchor UEs or the target UE, acting as a UE-A, transmits the SL Pos-RS. The above conditions may also depend on the positioning scenarios, for example based on absolute positioning, ranging, and/or positioning techniques. For RTT based ranging to determine the changing position accuracy, the location accuracy of the anchor UE or other reference UE, may not be necessary.

A hybrid request and condition based approach is now discussed. Instead of triggering the SL positioning by an explicit request or based on a condition, a hybrid approach can be adopted. As described above, the target UE can send a request for positioning including SL Pos-RS transmissions to anchor UEs or a serving anchor UE can send a positioning request to the target UE. However, the anchor UEs or the target UE may not immediately transmit SL Pos-RS. Instead, the anchor UE or the target UE can start sending SL Pos-RS and/or sending the measurement reports only when one or more conditions set for positioning are met.

The method or the container for the request can be any of the approaches discussed above. Similarly, the condition(s) for condition-based positioning can be applied in such hybrid approach.

Location information of the anchor/reference UE is now discussed. In NR positioning, the base station location is sent to UE via a system information block (SIB) message. However, there is no SIB message for SL. Location information of the anchor UEs should be delivered to the target UE or the serving anchor UEs in other ways. Anchor UEs may independently reserve resources and send their location information to other UEs via unicast, groupcast, or broadcast. The location information can be multiplexed with SL Pos-RS transmission.

A UE's location information may be a private information. A UE may be required to give approval to share location information with other UEs. This may be used as an indication for an anchor UE. A UE's approval on sharing of its location, if required, can be a necessary condition for the UE to be an anchor UE. A UE can indicate to other UEs that it can be an anchor UE only if the UE approves to share its location information.

Sidelink Positioning Reference Source (SL Pos-RS) is now discussed. SL Pos-RS can be used to denote a general positioning reference signal. A different positioning signal can be used for each technique. Several reference signals are specified. Among these, the appropriate reference signals for positioning can be synchronization signals or in general S-SSB, and SL CSI-RS. These two reference signals may be sufficient for RSRP or RSSI measurement in E-SID positioning techniques. For timing or angle estimation, an additional positioning signal for SL may be helpful. These reference signals and potential configurations are now discussed.

As described above, the periodicity of S-SSB with SL synchronization signals may be set for 160 ms. The number of S-SSB transmissions in each period is (pre-)configured. The following number of S-SSB transmissions in one period for (pre-)configuration has been specified, which is SCS dependent and frequency band dependent.
For FR1:
   For 15 kHz SCS, {1}
   For 30 kHz SCS, {1, 2}
   For 60 kHz SCS, {1, 2, 4}
For FR2:
   For 60 kHz SCS, {1, 2, 4, 8, 16, 32}
   For 120 kHz SCS, {1, 2, 4, 8, 16, 32, 64}

In addition to the number of transmissions within the 160 ms period, the transmissions of S-SSBs are based on two settings, the offset slot for the first S-SSB and the slot interval between two consecutive S-SSBs, which can be (pre-)configured. Other than these settings, the number of periods of S-SSB transmissions can be configured. In summary, the following is a list of configuration parameters among which one or more can be considered for SL positioning.
Number of transmissions
Slot offset for first S-SSB transmissions in one period
Intervals between two consecutive S-SSB's
Transmission periods

In addition, the following can be introduced for SL positioning purposes.
Time domain repetition: repeated S-SSB transmission e.g., multiple S-SSB transmissions in each S-SSB transmission internal.
Frequency domain repetition: multiple S-SSB transmissions on a different set of PRBs in the configured S-SSB slot.

In general, the configuration of S-SSBs cannot be changed dynamically. For positioning purposes, the following approaches can be employed for the configurations of the S-SSB transmissions.
The configurations are provided in the request message.
Two sets of pre-configurations of S-SSB. The S-SSB configured for positioning is transmitted once the positioning is triggered.
   S-SSB for synchronization and PSBCH
   S-SSB for additional purposes, e.g., positioning
Various (pre-)configuration of S-SSB. Upon positioning triggering, S-SSB according to one (pre-)configuration for positioning is transmitted. The configuration can be selected by the request or by the UE itself.
   Various configuration could mitigate S-SSB collisions as for positioning, S-SSBs are transmitted from multiple anchor UEs within a short period, e.g., in one 160 ms period.

SL CSI-RS is now discussed. To improve SL transmission efficiency, CSI-RS signals are used for the Rx UE to measure the sidelink channel quality for link adaptation. The CSI-RS for sidelink is the same as that for Uu link such as CSI-RS pattern. However, the difference is that in sidelink, CSI-RS is sent on the resources of the scheduled PSSCH. As such, it is multiplexed with an encoded transport block. Since the transmission of SL data is based on resource reservations, multiplexed CSI-RS transmission can avoid collisions with CSI-RS transmissions from other UEs.

In SL, the number of antenna ports for CSI-RS is up-to 2. For SL positioning, only one antenna port is used for SL Pos-RS transmissions unless the two antenna ports are not considered to be collocated. In such a case, both can be used as positioning references. The transmission and configuration of the SL PRS can modify the existing positioning configuration/procedures which are described below.

SL Pos-RS based on DL SRS or UL SRS for Positioning (SL PRS or SL SRS) is now discussed. Since the bandwidth of S-SSB is small and density of CSI-RS is low, they may not be appropriate for use as SL Pos-RS for timing-based or angle based positioning measurements. A different SL Pos-RS may be desired. UL SRS can be expanded with more signals for positioning purposes. Since UL SRS is designed for UE transmissions, UL SRS can be used in NR positioning for SL positioning, i.e., one of SL Pos-RS.

The following can be configured on UL SRS for positioning.
Comb size K_{TC}: 2, 4, 8
Number of OFDM symbols for UL SRS N_{symb}^{SRS}∈{1,2,4,8,12}
The starting OFDM symbol defined by an offset l_{offset}
Frequency domain offset
SRS sequence ID
Time domain periodicity T_{SRS} and offset T_{offset}
SRS BW or number of PRBs

The SRS as SL Pos-RS can be configured via one of the following alternative approaches.
The SRS configurations are provided in the request message.
Various (pre-)configuration of SRS for positioning, e.g., in the SL-SRS-PosResourceSet. Upon SL positioning triggering, one (pre-)configurated SL SRS for positioning is transmitted. The configuration can be selected via the request or by the UE itself (positioning/SL Pos-RS transmission triggered by a condition).

Since the bandwidth (BW) of the reference signal may be critical for the positioning accuracy with timing based positioning techniques, the configuration of SRS BW or the number of PRBs for SRS as SL Pos-RS may be important. Since SRS is transmitted across 4 consecutive PRBs, the subchannel for SRS transmission in sidelink as a SL Pos-RS transmission should be a multiple of 4 consecutive PRBs. The number of subchannels for SL SRS transmissions can be (pre)configured. For SL positioning, the number of subchannels for SRS can be specified in a range with a lower bound on minimum number of subchannels (or minimum number of PRBs) and an upper bound on maximum number of subchannels (or maximum number of PRBs). The upper bound can be the total number of subchannels or PRBs in the SL resource pool. The anchor UEs may reserve the resources for transmitting SL Pos-RS. For efficient transmission, the configuration on BW and/or number of PRBs for SL Pos-RS may be a range or a minimum number of subchannels. Anchor UE may decide the actual number of subchannels for SL Pos-RS transmissions.

Note that for positioning, the configuration and transmission of SL Pos-RS may not be limited to one type of SL Pos-RS. Multiple SL Pos-RS, such as S-SSB and SL PRS, can be configured and transmitted.

Behavior at positioning/target UE and hierarchy of anchor/reference UEs is now discussed. For the two types of UEs in the SL positioning system, a UE which provides the location reference is termed as an anchor UE and the UE whose location is to be estimated (either at the UE itself or at an anchor UE) as the target UE. The following terms may also be used for the two types of UEs. A UE with location reference may be known as an anchor UE, a reference UE, a location reference UE, a responding UE, and/or a source UE. A UE with a location to be estimated may be known as a positioning UE, a target UE, a location request UE, a request UE, and/or an initiating UE.

Although the UE with location to be estimated can be termed as a request UE or an initiating UE, the positioning request or initiation may not always originate at this UE. An anchor UE may also request or initiate a positioning process which includes the SL Pos-RS transmissions at the target UE. Also, the anchor UEs may have different location accuracies which depends on their sync signal/source that can be translated to a priority level based on the original source being global navigation satellite system (GNSS) or gNB/eNB.

Sidelink synchronization references, priorities, and hierarchy of SL positioning anchors is now discussed. In sidelink, there are four possible synchronization sources for a UE, and they include GNSS, a gNB/eNB, a synchronization reference (SyncRef) UE via S-SSB, and the UE's own internal clock. Among these synchronization sources, GNSS or eNB/gNB are regarded as the highest-quality sources. The SyncRef can be distinguished with the number of steps (hops) away from GNSS or a gNB/eNB. For example, the ones directly synchronized to GNSS or a gNB/eNB are 1 step away from GNSS or gNB/eNB. The sidelink synchronization procedure defines a hierarchy or set of priorities among such synchronization references and encourages all UEs to continuously search the hierarchy to get to the highest-quality synchronization reference(s) they can find. The synchronization preference orders are described in the following hierarchical priority levels, where lower number indicates higher priority.
Level 1. Either GNSS or eNB/gNB, according to (pre-)configuration.
Level 2. A SyncRef UE directly synchronized to a Level 1 source.
Level 3. A SyncRef UE synchronized to a Level 2 source, i.e. indirectly synchronized to a Level 1 source.
Level 4. Whichever of GNSS or eNB/gNB was not (pre-)configured as the Level 1 source.
Level 5. A SyncRef UE directly synchronized to a Level 4 source.
Level 6. A SyncRef UE synchronized to a Level 5 source, i.e. indirectly synchronized to a Level 4 source.
Level 7. Any other SyncRef UE.
Level 8. UE's internal clock.

Based on different sync references, the UE's qualification for being a positioning anchor can have a hierarchy of several levels due to different timing and location accuracies. The SL UE may obtain/derive its own location information from sources other than the sync source. There can also be a different hierarchy of levels. For example, gNB and GNSS as sync sources are considered at the same level. However, in terms of positioning performance, they may not be the same. Also, a SL UE connected to a gNB may obtain/derive its location from SL positioning, which can be treated with less priority/accuracy as an anchor. SL UE may broadcast or signal its level(s) of being anchor UE for SL positioning to the target UE.

On the other hand, there are 8 priority levels for sidelink data traffic, indicated by a 3-bit number, p=0, . . . ,7, in the priority field in SCI 1-A. Lower number indicates higher priority. The lowest level means the highest priority. The priority level is set by the application layer and is provided to the physical layer. The level of anchor UE and corresponding SL Pos-RS transmission may be translated and indicated by the 8 PHY priority levels.

Therefore, the sync source or the priority level can be the condition for a UE serving as an anchor UE or a target UE selecting an anchor UE. In addition, a UE's location accuracy based on positioning sources (which may be different from its sync source) can also set a qualification for the UE to be an anchor UE. The Sync source or priority range can be roughly estimated based on the in-coverage indicator I_{IC} and SLSS ID sent in S-SSB and SL-MIB. Correspondingly, the location information when transmitted can be assigned with a certain priority according to Sync reference source level. Note that the mapping may not be one-to-one with exact match as location information in general is a high priority information in SL positioning.

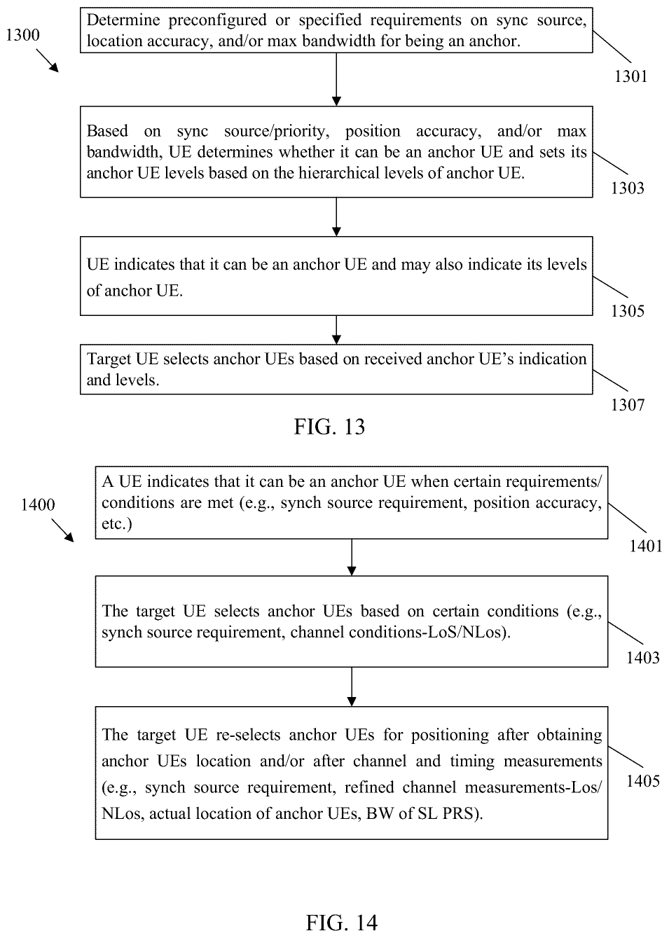

FIG. 13 is a flowchart of an example method 1300 for a UE to determine and indicate an anchor level to support UE anchor selection.

At step 1301, a UE can determine pre-configured or specified requirements on sync source, location accuracy, and/or max bandwidth for being an anchor. Given one or multiple hierarchical level structures of anchor UE, a UE can determine whether it can be an anchor UE at step 1303. The determination can be made according to (pre-)configured requirement(s) on the anchor levels of being an anchor UE based on the UE's sync source and/or priority, positioning source or positioning accuracy, and/or maximum BW. With the hierarchical level structure, the UE can determine its anchor level. The UE can then set an anchor level for itself based on the hierarchical levels defined for anchor UEs. The anchor level can be a single level metric which can be translated or mapped to SL PHY priority. The anchor level can also be a list for each metric that has a different associated anchor level, such as the UE's sync source, the UE's positioning source, etc. When the UE is qualified to be an anchor UE, the UE can send a signal for anchor indication at step 1305. The UE may also send the UE's anchor level(s). In some examples, the UE can send a signal indicating the UE is not and/or is no longer qualified to be an anchor UE at step 1305. The target UE receives the anchor indication and the anchor UEs anchor level(s). At step 1307, the target UE then selects anchor UEs according to the target UE's own requirement(s) based on the anchor UE's indications, metrics, and/or anchor levels received from the anchor UEs.

FIG. 14 is a flowchart of an example method 1400 for anchor UE selection. At step 1401, the UE can indicate that it can be an anchor UE when certain requirements/conditions are met. Such requirements/conditions can include synch source requirement, position accuracy, and/or any other conditions discussed herein. At step 1403, the target UE selects anchor UEs based on certain conditions. Such conditions may include sync source requirement, channel conditions-LOS/NLOS, and/or any other conditions discussed herein. At step 1405, the target UE can re-select anchor UEs for positioning after obtaining anchor UEs location and/or after channel and timing measurements, for example based on synch source requirement, refined channel measurements-LOS/NLOS, the actual location of anchor UEs, BW of SL Pos-RS (e.g., SL PRS), and/or any other conditions discussed herein.

In addition to the conditions set for a UE being an anchor UE or a target UE selecting an anchor UE, the target UE may further reselect anchor UEs and exclude some UE's SL Pos-RS and position information for positioning according to step 1405. This may occur after the SL Pos-RS transmission and based on sync source and/or priority levels of the anchor UEs and other conditions such as BW of SL Pos-RS signaling and location information of anchor UEs. Since the target UE does not know the anchor UE's location, location-based selections can be made after the transmission of anchor UE's location. For example, the target UE may select one or more anchor UEs from a group of UEs which may be very close to each other.

Therefore, given hierarchical levels of UE's qualification of being an anchor, several hierarchical structures for selecting anchor UEs can be employed. For example, such hierarchical levels can also include the channel quality when SL positioning is triggered.

Similarly, when the positioning is performed at the serving anchor UE, the serving anchor UE may select additional anchor UEs after obtaining the location information and/or use the measurement reports from a subset of coordinating anchor UEs. The behavior of the target UE can also be scenario dependent, e.g., absolute positioning or ranging.

Cast type of transmissions in the SL positioning process are now discussed. In many cases or scenarios, S-SSB transmissions are broadcast. For the case of SL positioning or SL Pos-RS transmissions, the following cast types for different types of transmissions can be supported.
Transmission of explicit request if the SL Pos-RS is triggered by a request:
   Unicast: the target UE sends the request to each anchor UE independently
   Groupcast: a group of anchor UEs is formed by the upper layer after anchor UE selection. The target UE groupcasts the request to the group of anchor UEs.
SL CSI-RS transmissions:
   Reuse rel-16 behaviour, unicast is supported.
SL Pos-RS (e.g., SL PRS) transmissions:
   Unicast: each anchor UE reserves the resources and transmits SL Pos-RS to the target UE via unicast.
   Broadcast: anchor UEs or the target UE (if positioning is done at serving anchor UE) broadcasts SL Pos-RS.
   Groupcast: the target UE can groupcast the SL Pos-RS to the anchor UE selected.

For SL positioning or SL Pos-RS transmission triggered by a condition, a broadcast or groupcast may be preferred.

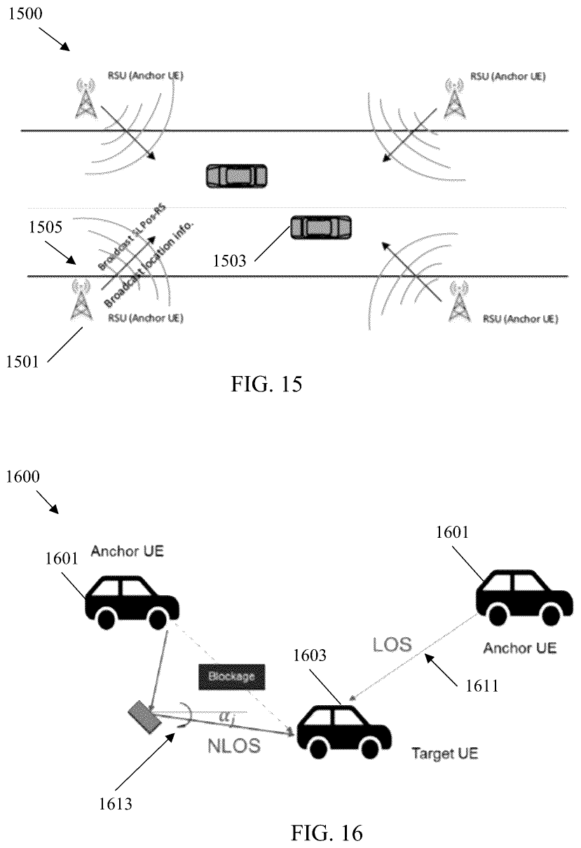

FIG. 15 is a schematic diagram 1500 illustrating anchor UEs broadcasting SL-Pos-RS and location/position information. It should be noted that location information and position information may be used interchangeably herein. In some scenarios broadcast techniques are more useful, for example when RSUs are acting as anchor UEs. Thus, interaction between anchor UEs and the target UE may preferably be very limited. The location information of the anchor UEs can also be broadcast to every UE either multiplexed with SL Pos-RS transmission or in a separate transmission. With broadcast of SL Pos-RS and anchor UEs' location information, UEs within the range of these anchor UEs benefit the positioning information. Diagram 1500 shows an exemplary case for V2x where anchor UEs 1501 are RSUs. The anchor UEs 1501 broadcast 1505 SL Pos-RS and their location information. For E-SID SL positioning technique, SL S-SSB may only be needed as a SL Pos-RS. The target UE 1503 can measure the RSRP on the DMRS in PSBCH and/or S-PSS or S-SSS in S-SSB.

Although positioning via timing-based measurement employs a large bandwidth of SL Pos-RS for high accuracy, broadcast may still be preferable for some scenarios/regions in V2X, public safety, and/or IIoT applications. Resource allocation may not be critical as in these scenarios. Hence, more positioning and less communication may be desired. Each anchor UE 1501 can reserve resources for broadcasting SL Pos-RS as well as the anchor UE's location formation for a certain period whenever positioning information is triggered by a request or condition as described herein.

SL resource allocation is now discussed. Resource allocation is employed for various transmissions during the SL position process, such as transmission of explicit request, transmission of SL Pos-RS, transmission of measurement report, and/or transmission of anchor UE's location information.

In general, each Tx UE can select resources for its own transmission based on (pre-)configured transmission settings, e.g., periodicity, etc. In one example, the transmissions of SL reference signal for positioning purposes may also employ a resource reservation. In some SL scenarios, anchor UEs may move or may be deployed dynamically. In one example an anchor UE may indicate that the locations of anchor UEs may be changed frequently. Therefore, the anchor UEs may update and communicate their locations to the target UEs. Also, depending on where the position of the target UE is estimated, measurements between the anchor UEs and target UE may be exchanged. These transmissions also employ resource allocations.

The positioning procedure involves information exchange between two sides, IUC scheme 1 can be revised as follows to assist other UEs for SL positioning transmissions:
Besides the request, the target UE, as UE-A, sends a preferred set of resources to each anchor UE (as UE B) for its SL Pos-RS transmissions. With such coordination, the collision of SL Pos-RS can be avoided.
The target UE as UE-A also sends the preferred resource set to each anchor UE (as UE-B) to transmit its location.
The (serving) anchor UE as UE-A sends the preferred resource set for the target UE (as UE-B) to transmit SL Pos-RS.
The (serving) anchor UE as UE-A sends the preferred resource set for the target UE (as UE-B) to send the measurement report.

Data multiplexing is now discussed. The transmission of the explicit request and SL Pos-RS may be multiplexed with other data. In an example, for the explicit request, the transmission can be multiplexed with data only if source/destination ID pair is the same. In an example, for the explicit request, the retransmission of the transmission is supported.

For SL Pos-RS transmissions, the following can be specified:
S-SSB: with the current frame structure, the S-SSB is not multiplexed with data
SL CSI-RS: based on Rel-16 spec, it can be multiplexed with data
SL PRS (SL SRS):
   For unicast: if same behavior as CSI-RS, it should be multiplexed with data (e.g., location information or measurement report).
   For groupcast/unicast, it can be multiplexed with data (e.g., location information or measurement report). Note that for SL PRS transmission, source/destination ID pair may not need to be the same as that for the data since SL PRS does not need a destination ID even if it is triggered by a specific UE and/or for a specific target UE.
   For broadcast, it can also be multiplexed with data if needed (e.g., location information of the anchor UEs or measurement report from target UE to anchor UEs or from coordinating anchor UEs to the serving anchor UE)

For transmission of the location information, the retransmission may not be needed as the location could change during the retransmission. The retransmission may be dropped or disabled based on the quality of location information, for example if the change of location is above a threshold or the speed of the UE is above a threshold.

For PSSCH RE mapping for the multiplexed data, the NR Positioning DL PRS RE mapping rule can be revised for the SL. To support legacy UEs which do not recognize SL Pos-RS, puncturing the data modulated symbols on the SL Pos-RS (SL PRS, SL SRS) REs allows for backward compatibility.

Due to a large bandwidth for each SL Pos-RS transmission, it may also be preferred that multiple UEs transmit different SL Pos-RS on the same resource on the same slot but orthogonal in time and frequency in the same RB. The UL SRS from different UEs can be sent on the same resources as long as they are on different REs. For sidelink, when SL Pos-RS signals from multiple anchor UEs are sent on the same resources, inter-symbol interference may appear due to different reception times at a UE. This may be mitigated by configuring the SL Pos-RS with the SL Pos-RS REs not appearing on the same subcarriers for the two consecutive OFDM symbols. Alternatively, this issue can be solved by configuring each PRS/SRS with a different offset so that there is one or more guard symbols between any two PRS/SRS's in time domain. In this case, the number of OFDM symbols for each PRS/SRS is four or less.

For SL Pos-RS signals from different UEs on the same resources, additional control signaling support is employed. For example, only one UE may send PSSCH for resource reservation or PSCCH may be allowed to signal overlapped resources for SL Pos-RS transmission without multiplexing with data.

As such, this disclosure focuses on the first artificial intelligence (AI) of the SL positioning regarding potential solutions for SL positioning and considers relative positioning, ranging, and absolute positioning. For this purpose, the reference signals for positioning are considered, including signal design, measurements, and associated procedures while reusing reference signals, procedures from sidelink communication, and positioning as much as possible.

Signal Bandwidths and signal to noise ratio (SNR) are now discussed. The channel bandwidth and the received SNR determines positioning accuracy for methods based on time-of-flight (TOF)/time of arrival (TOA) distance measurements. From Cramer-Rao lower bound (CRLB) analysis, the variance of the TOA measurements for the LOS channel is approximately lower bounded

$$var ( TOA ) \geq \frac{1}{8 {π}^{2} {β}^{2} SNR}$$

where R denotes the effective signal bandwidth and

$$β = \frac{{\int }_{- ∞}^{∞} {f}^{2} {\vert S ( f ) \vert}^{2} df}{{\int }_{- ∞}^{∞} {\vert S ( f ) \vert}^{2} df}$$

where SNR is the signal to noise ratio, f is the frequency and S(f) is the Fourier transform of the transmitted signal. The above inequality implies that higher signal bandwidth improves the TOA measurement accuracy. The investigation of the bandwidth impact on the location accuracy could indicate whether the SL positioning solutions should be extended or not to the unlicensed spectrum.

FIG. 16 is a schematic diagram 1600 of an example of LOS and NLOS sidelink positioning. If there is a direct LOS path 1611 between the anchor UE 1601 and the target UE 1603 nodes a larger positioning signal bandwidth allows a better resolution of multipath components, which increases the accuracy of finding the first path and thus reducing the error caused by multipath biases for TOA, RTT and TDOA based methods. However, if such direct LOS path 1611 does not exist and the communication between the anchor UE 1601 and target UE 1603 nodes is done via NLOS reflections 1613, the range between the anchor UE 1601 and the target UE 1603 nodes is overestimated due to the increased TOF. The angle of arrival (AOA) and angle of departures (AOD) estimations may be also affected by the NLOS propagation, which leads to low accuracy of the location estimates.

Time synchronization is now discussed. When a TOF and/or TOA based positioning method is used, the receiver may use the timestamp from the transmitter to estimate the TOF and thus the range between the transmitter and the receiver. However, even when the channel is LOS, if the clocks at the transmitter and receiver are not synchronized additional errors are introduced, which affect the ranging and the position estimations. The network synchronization error is defined as a truncated Gaussian distribution of root mean square (rms) values, denoted as (T1) in nanoseconds (ns), between the anchor node and a timing reference source which is assumed to have perfect timing, subject to the largest timing difference of T2 ns, where T2=2*T1. That is, the range of timing errors is [−T2, T2]. Two example values for T1 include 0 ns (perfectly synchronized) and 50 ns.

Some positioning methods such as the multi-RTT are robust with respect to time synchronization provided that the clock drifts are negligible for the duration when the difference of the received time and transmit time of the positioning signals are measured, while others are more sensitive to synchronization errors (such TOA). Therefore, when investigating SL positioning solutions, the synchronization errors between target and anchor nodes should be considered.

In an example, the SL positioning study should investigate the BW size, non-ideal synchronization, and NLOS propagation impact on the SL positioning accuracy. Methods for location determinations are now discussed.

The RAT-dependent methods for positioning are based on reference signal (RS) exchanges between the anchor nodes (gNB) and target nodes (UE). In this disclosure the target UE is the UE that requests position/location determination, and the anchor nodes are those nodes, such as UE, gNB, and/or RSU, that may be considered as reference for relative or absolute positioning of the target UE. The RAT dependent positioning methods are in addition to the RAT independent methods for positioning such as GNSS, Wi-Fi, Bluetooth, terrestrial beacon systems (TBS), and motion-based sensors. The RAT dependent methods are:
NR enhanced cell ID methods (NR E-CID) based on NR signals
Multi-Round Trip Time Positioning (Multi-RTT based on NR signals)
Downlink Angle-of-Departure (DL-AoD) based on NR signals
Downlink Time Difference of Arrival (DL-TDOA) based on NR signals
Uplink Time Difference of Arrival (UL-TDOA) based on NR signals;
Uplink Angle-of-Arrival (UL-AoA), including A-AoA and Z-AoA based on NR signals.
Hybrid positioning using multiple methods from the list of positioning methods above is also supported

The measurements to support the above methods are as follows.
Downlink PRS reference signal received power (DL PRS RSRP)
Downlink PRS reference signal received path power (DL PRS RSRPP)
Downlink PRS reference signal time difference (DL PRS RSTD)
UE Rx-Tx time difference

For sidelink positioning scenarios, at least one positioning reference signal is provided via sidelink (PC5), therefore a SL UE may combine and measure sidelink Pos-RS and DL PRS and transmit sidelink Pos-RS and UL PRS. For sidelink Mode 2 (expected in out of coverage scenarios) the reference nodes (anchor nodes) may be less reliable than for in coverage anchor nodes such as gNB. In these scenarios, it would be preferable to use positioning methods, such multi-RTT, which are more robust with respect to clock synchronization between anchor and target nodes.

For sidelink Mode 2 operation, robust positioning methods, such multi-RTT, may be preferable. The physical layer standards may be altered to support the SL UE positioning methods and measurements. For position determination SL UE should support the aggregation of DL PRS resources with SL positioning resources.

One basic scenario for positioning in 5G services is the support of positioning in OOC scenarios when all the devices involved in the SL positioning are out of reach of LMF. The OOC scenario positioning is part of the study item description (SID). The 5G system should provide positioning information for a UE that is out of coverage of the network, with accuracy of <[1 m] relative to other UEs that are in proximity and in coverage of the network. This positioning support allows data to be available at the UE, which makes possible UE based positioning and positioning in OOC scenarios.

The 5G system should be able to make the position-related data available to an application or to an application server existing within the 5G network, external to the 5G network, or in the User Equipment. In the OOC case, it is not clear whether a similar entity to LMF is still necessary and if so where it should be located. The target UE should support a function that allows it to compute an estimation of the location. Such functionality and complexity may depend on the OOC covered scenarios such ranging, relative positioning, or absolute positioning.

The SL positioning solutions for OOC scenarios should be able to select the positioning method, to configure and enable the sidelink reference signal transmissions per request or triggered by an event, to select the anchor nodes and enable RRC connectivity if necessary, to obtain the location information or to request SL Pos-RS transmissions, to provide or exchange the location information if requested, to configure and enable the collection of SL positioning measurements to estimate the relative or the absolute position.

Some of the positioning methods involve an exchange between the target node and anchor nodes. For instance, in a UE based positioning multi-RTT the anchor nodes should provide the SL UE target node the measurements of Rx-Tx, which will be combined with the Rx-Tx measurements at the target node to obtain the final position estimation. Another example of data exchange between target node and anchor nodes may be the absolute position coordinates provided by the anchor nodes to the target node. Such exchange may be carried out only after a RRC connection is established between the target and anchor nodes that could enable data encryption and therefore privacy.

The SL positioning solutions should support the configurations and controls for OOC SL positioning. These scenarios for the OOC SL positioning solutions may be achieved by two possible approaches. One option is to start from scratch and define protocols and signaling that would support the SL positioning methods. Another option is to build on the SL design and to extend the protocols with the signaling that implements the SL positioning methods. The Inter UE Coordination (IUC) feature is a candidate that may be considered and extended to support the SL positioning solutions for the OOC scenarios. The IUC feature offers the framework to request and respond for the measurements and location information, to configure and trigger the necessary signaling, and to coordinate the transmissions of the anchor nodes. In addition, using the IUC feature would minimize the specifications impact.

The IUC framework for OOC SL positioning solutions may be extended and/or used.

The Position reference signal is now discussed. The RAT-dependent methods for positioning are based on reference signal (RS) exchanges between the anchor nodes (gNB) and target UE. More precisely, the gNB transmits a DL positioning RS (DL PRS) signal. The UE transmits an UL sounding reference signal (UL PRS) based on a configuration provided by SRS-PosResourceSet, which differs from the SRS used for UL channel estimation based on a configuration given by SRS-ResourceSet.

The DL PRS signal is a length-31 Gold QPSK sequence, where the pseudo-random sequence generator is initialized based on the slot number, the DL PRS sequence ID, n_{ID,seq}^{PRS} ∈{0,1, . . . ,4095} and the OFDM symbol index in the slot to which the sequence is mapped. The PRS sequence ID allows frequency reuse, while the slot and symbol indices allow the TOF, TOA, TDOA and RTT determination.

In time domain, the size of the DL PRS resources is L_{PRS}∈{2,4,6,12} symbols and it is given by the higher-layer parameter dl-PRS-NumSymbols.

In frequency domain a PRS resource has a comb distribution (e.g., resource element (RE) spacing in each symbol of DL-PRS Resource) where the comb size K_{comb}^{PRS}∈{2,4,6,12} is given by the higher-layer parameter dl-PRS-CombSizeN-AndReOffset for a downlink PRS resource configured for RTT-based propagation delay compensation, otherwise by the higher-layer parameter dl-PRS-CombSizeN such that the combination {LL_{PRS}, K_{comb}^{PRS}} is one of {2, 2}, {4, 2}, {6, 2}, {12, 2}, {4, 4}, {12, 4}, {6, 6}, {12, 6} and {12, 12}.

The comb distribution allows a wider bandwidth of the RS signal, and therefore as better accuracy for TOA estimation. However, the gaps in frequency generate aliases in time, which may be compensated by the repetition of PRS in time and coherent combining. For instance, if two symbols with comb-4 are coherently combined, the result is equivalent with a comb-2 PRS signal.

The frequency offset from symbol to symbol is selected such that there is no staircase pattern. This has the main advantage that increases the robustness (for instance against Doppler shifts) when using just the first symbols for a coherent combining. In addition, the comb design and the offset in frequency between the consecutive symbols offers an increase in robustness to the wideband fading, and an orthogonality with respect to other PRS signals from other TRPs.

A PRS resource is defined by ID, sequence ID {0, . . . ,4095}, the comb size {2,4,6,12} and the RE offsets for the remaining symbols, resource slot offset, resource symbol offset, and QCL information. A DL PRS resource set is configured by NR-DL-PRS-ResourceSet, comprises one or more DL PRS resources, where each resource has an associated spatial transmission filter (transmission direction).

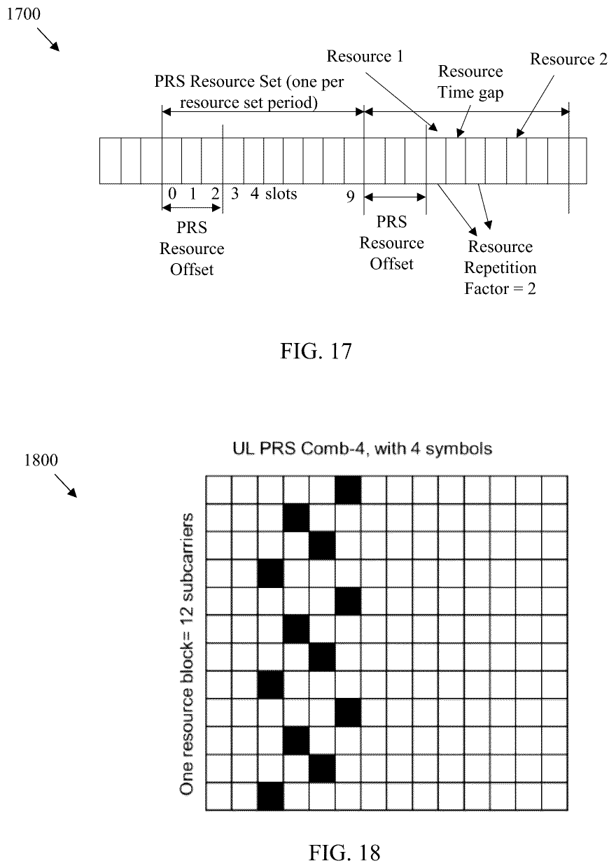

FIG. 17 is a schematic diagram of an example of positioning reference signal (PRS) resource set 1700. The PRS resource set 1700 is characterized by ID, subcarrier spacing, periodicity (of the resource set transmissions), resource list, resource repetition factor (number of repetitions of each resource during an instance of the resource set), resource time gap (a number of slots between resource consecutive repetitions), comb size, resource bandwidth (between 24 PRBs and 272 PRBs in 4 PRBs increment), the start of PRB index, and the number of resource symbols in the PRS slot. The PRS resource set 1700 can be located anywhere in the frequency grid via the start of PRB index, which is an offset with respect to the reference frequency Point A.

A PRS resource set is sent by gNB with a periodicity of Tₚₑᵣ^{PRS}∈2^{μ}{4,5,8,10,16,20,32,40,64,80,160,320,640,1280,2560,5120,10240} slots.

The PRS resource repetition factor defines how many times each DL-PRS resource is repeated for a single instance of the DL-PRS resource set and may take values Tᵣₑₚ^{PRS}∈{1,2,4,6,8,16,32}. All the DL PRS resources within one resource set have the same resource repetition factor.

To mitigate interference on weak PRS signals, the strong PRS signals may be muted. The muting pattern is specified by a bit string of {2,4,8,16,32} bits in each cell, where a bit indicates if the PRS transmission in the corresponding slot is muted or not.

A UE in RRC connected state is required to measure the DL PRS only in the active bandwidth part (BWP) and with the same numerology as the active BWP. UE may request the serving gNB measurement gaps that can be used to measure DL PRS outside the active BWP and with different numerology.

For 15 kHz SCS the minimum DL PRS is about 5 megahertz (MHz) and the maximum about 50 MHz. With a 120 kilohertz (kHz) SCS the DL PRS minimum bandwidth is about 34 MHz, and the maximum bandwidth is about 400 MHz.

FIG. 18 is a schematic diagram of an example UL PRS 1800 resource configuration. The UL PRS 1800 is based on the sounding RS (SRS) and referred as SRS for positioning. The UL PRS 1800 sequence is 31-bit Zadoff-Chu, which offers good peak to average ratio. The UL PRS 1800 may span in time for {1,2,4,8,12} consecutive OFDM symbols, which can be located anywhere in the slot. Similar with DL PRS, the UL PRS 1800 has a comb-N pattern in frequency, with comb size {2,4,8}. Like UL PRS 1800, the DL PRS has a comb offset which defines the relative frequency shifts between consecutive OFDM symbols. The offset offers similar advantage as for DL PRS. Only the first few symbols may be considered for TOA measurement through a coherent combining. Like DL PRS, the UL PRS 1800 may be transmitted periodically with certain periodicity and slot offset. However, the semi-persistent configuration is activated and deactivated via MAC-CE signaling. An aperiodic UL PRS 1800 is transmitted only when UE is instructed by gNB via Downlink Control Information (DCI). UL PRS 1800 supports spatial relationships, where the spatial relationship can be either a DL reference signal (SSB, CSI-RS or DL-PRS) or by the previously transmitted SRS or UL-PRS 1800. The UL PRS 1800 can also have a spatial relationship with a neighbor transmit receive point (TRP).

Another property of the UL PRS 1800 is the power transmit control, where UE estimates the UL pathloss for serving and neighbor TRPs based on DL measurements and sets the UL PRS 1800 power accordingly. The UL PRS 1800 resource set comprises of one or multiple UL PRS resources, and is defined by resource set ID, resource type (aperiodic, semi-persistent, periodic), alpha the value that characterizes the fractional power control, p0 the desired receive power at TRP, pathloss reference RS and the UL PRS resource list.

The UL resource is described by an ID, transmission comb, resource mapping (symbol location in UL PRS 1800 slot), frequency domain shift, bandwidth indication (as part of the Frequency Hopping, which is not used for frequency hopping indication as for SRS case), resource type (periodic, semi-persistent, aperiodic), the corresponding periodicity, a sequence ID used to initialize the pseudo-random group, a sequence hopping, and a spatial relation information.

Like for DL PRS, the UE may be configured with multiple UL PRS resource sets.

Reference signals for sidelink positioning are now discussed.

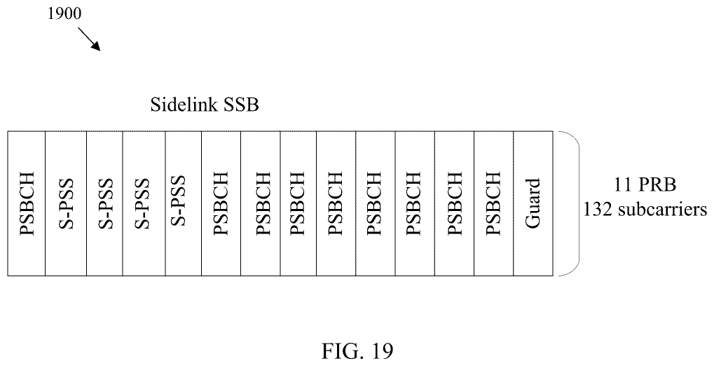

FIG. 19 is a schematic diagram of an example S-SSB 1900. S-SSB 1900 is a broadcast signal, which is used for the synchronization purposes, and it is composed of the Sidelink Primary Synchronization Signal (S-PSS), Sidelink Secondary Synchronization Signal (S-SSS), and Physical Sidelink Broadcast Channel (PSBCH). There are 672 unique physical layer sidelink synchronization identities, and they are divided into two sets {0,1, . . . , 335} and {336, . . . ,671}. The Sidelink Synchronization Signal ID (SLSSID) indicates the source of time reference (GNSS, gNB or another SL UE (SyncRef UE)), and therefore give an information of the accuracy of the time reference. Prior to start sending S-SSB 1900 a SL UE must select its own time reference and advertise it via SLSSID.

In the frequency domain S-SSB 1900 occupies 11 Physical Resource Blocks (PRBs), i.e, 132 subcarriers, where S-PSS and S-SSS each occupy 127 subcarriers and are repeated twice during the S-SSB slot. The PSBCH occupies 132 subcarriers for the duration of eight symbols (FIG. 5). The first PSBCH symbol serves for automatic gain control (AGC) purpose. Each S-SSB transmission is repeated one or several times during each period of 16 subframes. The frequency location of S-SSB is fixed.

The S-SSB 1900 may be used primarily by a receiver SL UE to acquire synchronization with the transmitter SL device, or for the target SL UE to measure Time Difference of Arrival (TDOA) between two SyncRef UE that are synchronized with the same reference time. Thus, the target SL UE could estimate relative position to SyncRef UE.

The S-SSB can be adapted to estimate the TDOA between anchor SL devices. The accuracy of TDOA estimate is increased when the S-SSB originators have the same reference time (SLSSID). The usage of S-SSB for positioning may enable SL UE positioning in RRC_INACTIVE state. The S-SSB based SL position determination may be supported by the network.

Sidelink Positioning Signal (SL Pos-RS) is now discussed. One of the topics of this study item relates to the study of sidelink reference signals for positioning purposes from physical layer perspective, including signal design, resource allocation, measurements, associated procedures, etc, using reference signals, procedures, etc from sidelink communication and from positioning as much as possible.

In out-of-coverage (OOC) scenarios, the target SL UE may rely on the sidelink (PC5) reference signals received from other SL devices (SL UE, RSU) to determine the range, or position. The signal bandwidth plays a role in estimation accuracy. The bandwidth of S-SSB may not be sufficient, moreover the S-SSB periodicity (160 ms) may add additional latency to position determination. Thus, RANi may define a SL Pos-RS that shares some of the common features of DL and UL PRS such as
Flexible bandwidth size
Comb-N distribution in frequency
Repetition with frequency offset in consecutive symbols
Different length in time, and periodicity of the resource set
Aperiodic, semi-static and periodic transmissions

The Zadoff-Chu (ZC) sequence used for uplink PRS offers better PAPR properties (small power variations in time and frequency) with respect to Gold Sequence used for DL PRS. Such PAPR properties may be desirable for SL UE to avoid nonlinear signal distortions.

RAN1 may consider the UL PRS design as the starting point of the SL Pos-RS design. A SL UE at the fringe of the network coverage may participate in a SL positioning exchange with other SL UEs in partial coverage. Thus, the serving gNB should be able to control and configure the SL Pos-RS UE transmissions in its coverage to minimize interference and maximize capacity. The SL Pos-RS configuration may be controlled by gNB when SL UEs are in coverage or partial coverage.

SL positioning architecture is now discussed.

UE positioning can be performed in NG-RAN. The positioning methods, positioning architecture and signaling protocols and interfaces are defined. Positioning solutions rely on LTE Positioning Protocol (LPP) and Location Management Function (LMF). Particularly the LMF is used for the orchestration of the positioning methods and protocols.

For positioning of a target UE, the LMF decides on the positioning methods to be used, based on factors that may include the LCS Client type, the required QoS, UE positioning capabilities, gNB positioning capabilities and ng-eNB positioning capabilities. The LMF then invokes these positioning methods in the UE, serving gNB and/or serving ng-eNB. The positioning methods may yield a location estimate for UE-based position methods and/or positioning measurements for UE-assisted and network-based position methods. The LMF may combine all the received results and determine a single location estimate for the target UE (hybrid positioning).

When SL UEs that participate in positioning exchange are in coverage of gNB, the positioning protocol (LTE Positioning Protocol) should be still supported. The LMF through Uu connections and SL relaying should be able to coordinate and process the measurements for positioning. At the same time, gNB may forward the measurements from the SL UE to the LMF to estimate the position of the SL UE in partial coverage.

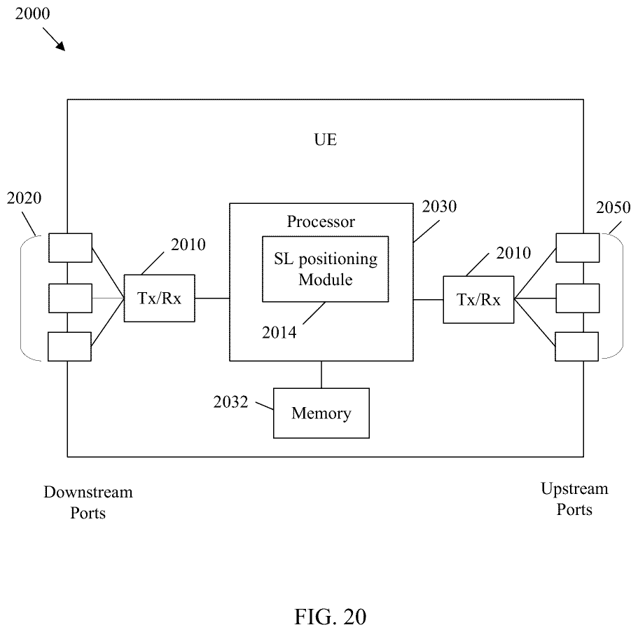

FIG. 20 is a schematic diagram of an example UE 2000 for sidelink communication. The UE 2000 can be used as a target UE, and anchor UE, or any other UE described herein. Accordingly, the UE 2000 may be configured to implement or support the schemes/features/methods described herein. For instance, the features/methods in the disclosure may be implemented using hardware, firmware, and/or software installed to run on hardware. One skilled in the art will recognize that the term UE encompasses a broad range of devices of which UE 2000 is merely an example. UE 2000 is included for purposes of clarity of discussion, but is in no way meant to limit the application of the present disclosure to a particular network device embodiment or class of network device embodiments.

The UE 2000 may be a device that communicates electrical, wireless, and/or optical signals through a network. As shown in FIG. 20, the UE 2000 may comprise transceivers (Tx/Rx) 2010, which may be transmitters, receivers, or combinations thereof. A Tx/Rx 2010 may be coupled to a plurality of downstream ports 2020 (e.g., downstream interfaces) for transmitting and/or receiving frames from other nodes and a Tx/Rx 2010 coupled to a plurality of upstream ports 2050 (e.g., upstream interfaces) for transmitting and/or receiving frames from other nodes, respectively. A processor 2030 may be coupled to the Tx/Rxs 2010 to process the data signals and/or determine which nodes to send data signals to. The processor 2030 may comprise one or more multi-core processors and/or memory devices 2032, which may function as data stores, buffers, etc. Processor 2030 may be implemented as a general processor or may be part of one or more application specific integrated circuits (ASICs) and/or digital signal processors (DSPs). The UE 2000 may comprise a SL positioning module 2014, which may be configured to employ sidelink communications to initial SL based positioning mechanisms as described herein. The SL positioning module 2014 may be implemented in a general purpose processor, a field programmable gate array (FPGA), an ASIC, a DSP, a microcontroller, etc. In alternative embodiments, the SL positioning module 2014 may be implemented in processor 2030 as computer executable instructions stored in memory device 2032 (e.g., as a computer program product stored in a non-transitory computer readable medium), which may be executed by processor 2030, and/or implemented in part in the processor 2030 and in part in the memory device 2032. The downstream ports 2020 and/or upstream ports 2050 may contain wireless, electrical, and/or optical transmitting and/or receiving components, depending on the embodiment.

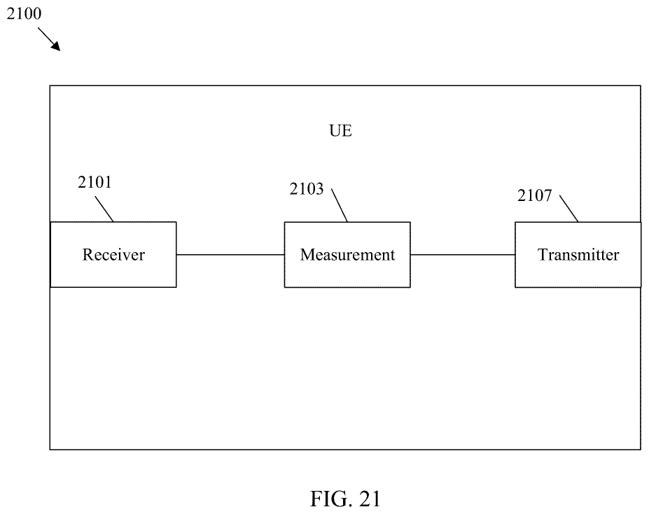

FIG. 21 is a schematic diagram of an example embodiment of a UE 2100 for sidelink positioning. The UE 2100 can be used as a target UE, and an anchor UE, or any other UE described herein. The UE 2100 comprises a receiver 2101, a measurement module 2103, and a transmitter 2107. In an example, the transmitter 2107 acts as a transmitting means for transmitting a positioning request to one or more anchor UEs via a sidelink communication. Further, the receiver 2101 acts as a receiving means for receiving a positioning signal from the one or more anchor UEs via the sidelink communication. In addition, the measurement module 2103 acts as a measurement means for performing a positioning measurement based on the positioning signal.

In another example, the transmitter 2107 acts as a transmitting means for transmitting a positioning request to a target UE via a sidelink communication. Further, the receiver 2101 acts as a receiving means for receiving a positioning signal from the target UE via the sidelink communication. In addition, the measurement module 2103 acts as a measurement means for performing a positioning measurement for the target UE based on the positioning signal.

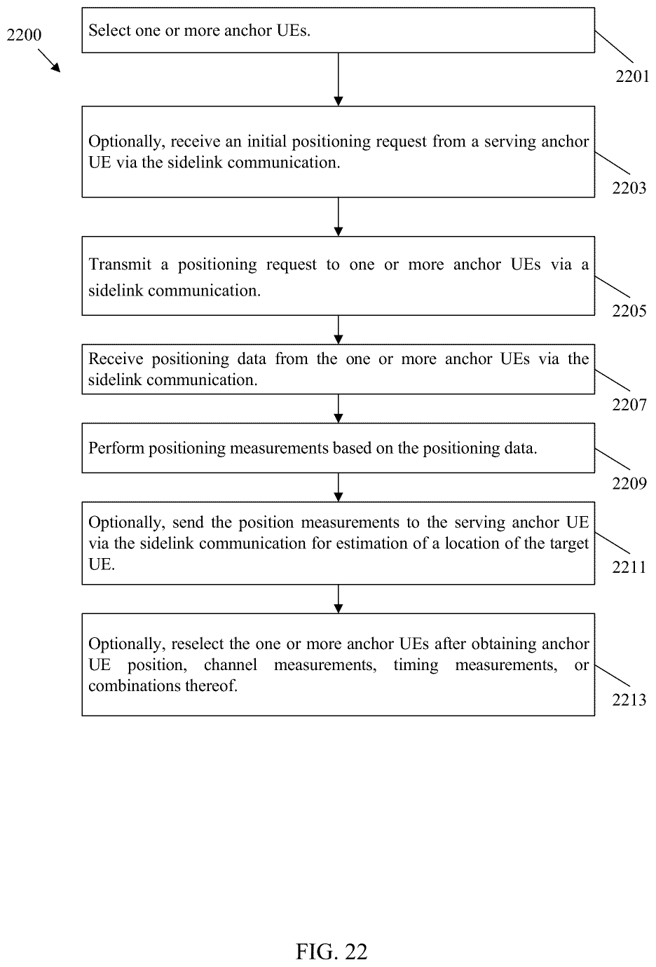

FIG. 22 is a flowchart of an example method 2200 of performing sidelink based positioning in a target UE. At step 2201, the target UE selects one or more anchor UEs. In an example, the one or more anchor UEs are selected based on a UE anchor indication and UE anchor levels. For example, the UE anchor indication may indicate whether a corresponding UE is capable of acting as an anchor UE and whether the corresponding UE is allowed to act as an anchor UE. In an example, the UE anchor levels may be set based on synchronization source, priority level, location accuracy, maximum bandwidth, in-coverage indicator, SLSSID, or combinations thereof.

Positioning may be managed by a target UE, by an anchor UE, and/or by a serving anchor UE in conjunction with coordinating anchor UEs. At step 2203, the target UE may optionally receive an initial positioning request from a serving anchor UE via the sidelink communication. This may occur when a serving anchor UE is managing the positioning.

At step 2205, the target UE transmits a positioning request to one or more anchor UEs via a sidelink communication. In an example, the positioning request can be triggered by the target UE. In other examples, the positioning request can be triggered by the initial positioning request from a serving anchor UE at step 2203, in which case the one or more anchor UEs are coordinating anchor UEs. In some examples, the positioning request is triggered by a condition. For example, the condition may include comparison of a RSRP relative to a first threshold, a distance relative to a second threshold, a number of UE anchors relative to a third threshold, a channel condition relative to a fourth threshold, or combinations thereof.

It should be noted that the target UE can communicate with the anchor UEs according to mode 1 or mode 2. In mode 1, the target UE is in range of a 5G network. In such a case, the target UE may communicate with the one or more anchor UEs via resource reservations provided by a gNB. In mode 2, the target UE is out of range of the network. In such a case, the target UE communicates with the one or more anchor UEs in accordance with sensing based resource selection of sidelink resources. This approach may use opportunistic signaling to select communication resources without communication with the 5G network.

At step 2207, the target UE receives a positioning signal from the one or more anchor UEs via the sidelink communication. The positioning signal may comprise SL-Pos-RS.

At step 2209, the UE may perform a positioning measurement based on the positioning signal. For example, the target UE may estimate a location of the target UE based on the positioning measurement and a location of the one or more anchor nodes.

At step 2211, the target UE may optionally send the position measurement to the serving anchor UE via the sidelink communication for estimation of a location of the target UE. In some examples, the target UE instead sends a report to the serving anchor UE indicating the location of the target UE based on step 2209. In some examples, the target UE may also send a report to the serving anchor UE related to a positioning signal received from the coordinating anchor UEs.

At step 2213, the target UE may optionally reselect the one or more anchor UEs after obtaining anchor UE position, channel measurements, timing measurements, or combinations thereof.

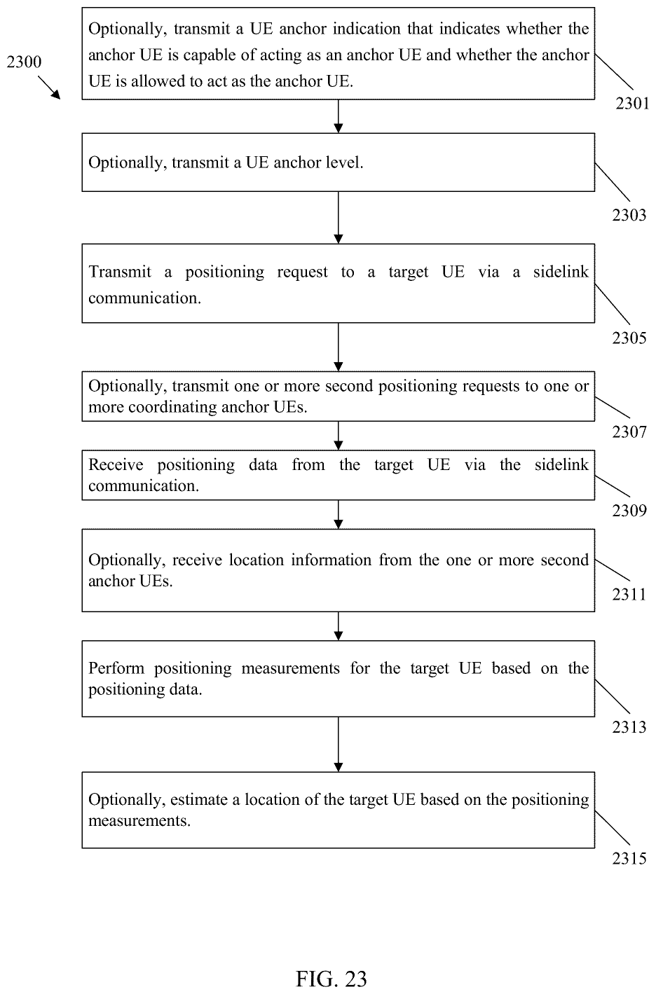

FIG. 23 is a flowchart of an example method 2300 of performing sidelink based positioning in an anchor UE. In optional step 2301, the anchor UE may transmit a UE anchor indication that indicates whether the anchor UE is capable of acting as an anchor UE and whether the anchor UE is allowed to act (e.g., wants to act) as the anchor UE. In step 2303, the anchor UE may optionally transmit a UE anchor level set based on a synchronization source, a priority level, location accuracy, a maximum bandwidth, an in-coverage indicator, a sidelink synchronization signal identifier (SLSSID), or combinations thereof. Optional steps 2301 and 2303 allow the anchor UE to indicate to potential target UEs whether the anchor UE can be selected as an anchor UE for purposes of positioning and also allows the target UE to determine which anchor UEs should be selected for best results.

At step 2305, the anchor UE transmits a positioning request to a target UE via a sidelink communication. In some cases, the anchor node acts as a serving anchor node. In some examples, the positioning request may signal the target UE to send one or more second positioning requests to one or more coordinating anchor UEs. In some examples, the positioning request is triggered by a condition. For example, the condition may include RSRP relative to a first threshold, a distance relative to a second threshold, a number of UE anchors relative to a third threshold, a channel condition relative to a fourth threshold, or combinations thereof.

It should be noted that the anchor UE can communicate with the target UE according to mode 1 or mode 2. In mode 1, the anchor UE is in range of a 5G network. In such a case, the anchor UE may communicate with the target UE via resource reservations provided by a gNB. In mode 2, the anchor UE is out of range of the network. In such a case, the anchor UE communicates with the target UE in accordance with sensing based resource selection of sidelink resources. This approach may use opportunistic signaling to select communication resources without communication with the 5G network.

At optional step 2307, the anchor node may act as a serving anchor node and may transmit one or more second positioning requests to one or more coordinating anchor UEs instead of delegating such transmissions to the target UE.

At step 2309, the anchor node receives a positioning signal from the target UE via the sidelink communication. For example, the positioning signal may comprise a SL-Pos-RS. In some examples, the positioning signal from the target UE also includes location information from the one or more coordinating anchor UEs.

At step 2311, the anchor UE may optionally receive location information from the one or more coordinating anchor UEs instead of receiving such information via the target UE.

At step 2313, the anchor UE performs a positioning measurement for the target UE based on the positioning signal.

At step 2315, the anchor UE may estimate a location of the target UE based on the positioning measurement from the target UE and/or location information from the one or more coordinating anchor UEs. In some examples, the target UE may instead estimate its own location. In such a case, the anchor UE may receive a report from the target UE indicating the target UE's position.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a target User Equipment (UE), the method comprising:
transmitting a positioning request to one or more anchor UEs via a sidelink communication;
receiving a positioning signal from the one or more anchor UEs via the sidelink communication; and
performing a positioning measurement based on the positioning signal.

2. The method of claim 1, wherein the target UE communicates with the one or more anchor UEs in accordance with sensing based resource selection of sidelink resources.

3. The method of claim 1, wherein the target UE communicates with the one or more anchor UEs via resource reservations provided by a fifth generation (5G) base station (gNB).

4. The method of claim 1, wherein the positioning signal comprises a sidelink positioning reference signal (SL Pos-RS), and wherein the positioning request comprises at least one of an SL Pos-RS signaling option or an SL Pos-RS signaling configuration.

5. The method of claim 1, further comprising selecting the one or more anchor UEs from a plurality of anchor UEs prior to transmitting the positioning request to the one or more anchor UEs.

6. The method of claim 1, further comprising estimating a location of the target UE based on the positioning measurement and a location of the one or more anchor UEs.

7. The method of claim 1, further comprising:
receiving an initial positioning request from a serving anchor UE via the sidelink communication prior to transmitting the positioning request to the one or more anchor UEs; and
sending the positioning measurement to the serving anchor UE via the sidelink communication for estimation of a location of the target UE.

8. The method of claim 1, wherein transmitting the positioning request is triggered by a condition, the condition comprising at least one of reference signal received power (RSRP) relative to a first threshold, a distance relative to a second threshold, a number of UE anchors relative to a third threshold, or a channel condition relative to a fourth threshold.

9. The method of claim 1, wherein the one or more anchor UEs are selected based on one or more UE anchor indications and one or more UE anchor levels, wherein the one or more UE anchor indications indicate whether a corresponding UE is capable of acting as an anchor UE and whether the corresponding UE is allowed to act as an anchor UE, and wherein the one or more UE anchor levels are set based on at least one of a synchronization source, priority level, a location accuracy, a maximum bandwidth, an in-coverage indicator, or a sidelink synchronization signal identifier (SLSSID).

10. The method of claim 1, further comprising reselecting the one or more anchor UEs after obtaining at least one of anchor UE position, channel measurements, or timing measurements.

11. A method implemented by an anchor User Equipment (UE), the method comprising:
transmitting a positioning request to a target UE via a sidelink communication;
receiving a positioning signal from the target UE via the sidelink communication; and
performing a positioning measurement for the target UE based on the positioning signal.

12. The method of claim 11, wherein the positioning signal comprise a sidelink positioning reference signal (SL Pos-RS).

13. The method of claim 11, further comprising estimating a location of the target UE based on the positioning measurement.

14. The method of claim 11, wherein the positioning request triggers the target UE to send one or more second positioning requests to one or more coordinating anchor UEs, and wherein the positioning signal from the target UE includes location information from the one or more coordinating anchor UEs.

15. The method of claim 11, further comprising receiving location information from one or more coordinating anchor UEs.

16. The method of claim 11, further comprising transmitting one or more second positioning requests to one or more coordinating anchor UEs.

17. The method of claim 11, wherein the positioning request is triggered by a condition, wherein the condition includes at least one of reference signal received power (RSRP) relative to a first threshold, a distance relative to a second threshold, a number of UE anchors relative to a third threshold, or a channel condition relative to a fourth threshold.

18. The method of claim 11, further comprising transmitting a UE anchor indication that indicates whether the anchor UE is capable of acting as an anchor UE and whether the anchor UE is allowed to act as the anchor UE.

19. The method of claim 11, further comprising transmitting a UE anchor level set based on at least one of a synchronization source, a priority level, location accuracy, a maximum bandwidth, an in-coverage indicator, or a sidelink synchronization signal identifier (SLSSID.

20. The method of claim 11, wherein an anchor UE is selected in accordance with a line-of-sight (LOS)/non line-of-sight (NLOS) indicator.
